(19) United States
(12) Patent Application Publication
(10) Pub. No.: US 2026/0140464 A1
(43) Pub. Date: May 21, 2026

(54) PROCESSING DEVICE, CONTROL METHOD, AND TRANSFER MEDIUM

(71) Applicant: BROTHER KOGYO KABUSHIKI KAISHA, Nagoya (JP)

(72) Inventors: Daisuke KAWASE, Konan (JP); Akihiro KAWAKITA, Okazaki (JP); Shuichi TAMAKI, Nagoya (JP)

(21) Appl. No.: 19/384,479

(22) Filed: Nov. 10, 2025

(30) Foreign Application Priority Data
Nov. 15, 2024 (JP) 2024-199473

(51) Int. Cl. G03G 15/16; G03G 15/00

(52) U.S. Cl. CPC G03G 15/165; G03G 15/607

(57) ABSTRACT

A processing device includes a process portion and a processor. The process portion performs medium processing on a transfer medium, subsequent to or prior to ejection of ink forming an image to be transferred from the transfer medium to a transfer-receival medium. The processor causes the process portion to perform one of the medium processing of forming additional information on the transfer medium in a non-transfer mode, or the medium processing of implementing a restriction procedure on the additional information formed on the transfer medium, or the medium processing of implementing an image transfer procedure on the image formed on the transfer medium and not implementing an information transfer procedure on the additional information formed on the transfer medium.

### SPECIFICATION

### REFERENCE TO RELATED APPLICATIONS

This application claims priority from Japanese Patent Application No. 2024-199473 filed on November 15, 2024. The entire content of the priority application is incorporated herein by reference.

### BACKGROUND ART

An image formation method includes an image formation process and a transfer process. In the image formation method, the image formation process and the transfer process are performed in the order of the image formation process and the transfer process. In the image formation process, an image is formed on a transfer medium. In the transfer process, the transfer medium on which the image is formed is pressed against a transfer-receival medium. In this way, in the transfer process, the image is transferred from the transfer medium to the transfer-receival medium.

### SUMMARY

In the above-described image formation method, additional information separate from the image is conceivably formed on the transfer medium.

The additional information may conceivably be used for one or more objectives that differ from a usage objective of the image, for example. For example, the additional information is conceivably used for distinguishing one of the transfer media from other transfer media. For example, the additional information is conceivably used for distinguishing the image formed on the transfer medium from other images. For example, the additional information is conceivably used for specifying a position of the image with respect to the transfer medium. For example, the additional information is conceivably used for specifying a position at which the transfer medium is to be cut.

In a case where the additional information is formed on the transfer medium separately from the image in the image formation process, in the transfer process, the additional information may possibly be transferred to the transfer-receival medium together with the image.

Embodiments of the broad principles derived herein provide a processing device, a control method, and a transfer medium that contribute to suppressing additional information from being transferred from the transfer medium onto a transfer-receival medium in a transfer process.

A first aspect of the present disclosure relates to a processing device. The processing device includes a process portion configured to perform medium processing on a transfer medium, subsequent to or prior to ejection of ink. The ink is configured to form an image to be transferred from the transfer medium to a transfer-receival medium. The processing device includes a processor. The processor is configured to cause the process portion to perform one of the medium processing of forming additional information on the transfer medium in a non-transfer mode, or the medium processing of implementing a restriction procedure on the additional information formed on the transfer medium, or the medium processing of implementing an image transfer procedure on the image formed on the transfer medium, and not implementing an information transfer procedure on the additional information formed on the transfer medium. The non-transfer mode is a mode in which the additional information is not transferred from the transfer medium to the transfer-receival medium in a transfer process of transferring the image from the transfer medium to the transfer-receival medium. The restriction procedure is a procedure that restricts the information transfer procedure from being implemented on the additional information formed on the transfer medium. The information transfer procedure is a procedure for transferring the additional information from the transfer medium to the transfer-receival medium in the transfer process. The image transfer procedure is a procedure for transferring the image from the transfer medium to the transfer-receival medium in the transfer process.

According to the first aspect, the additional information is formed on the transfer medium in the non-transfer mode, or the restriction procedure is implemented on the additional information, or the information transfer procedure is not implemented on the additional information. Thus, the processing device contributes to suppressing the additional information from being transferred from the transfer medium to the transfer-receival medium in the transfer process.

A second aspect of the present disclosure relates to a control method for controlling a process portion configured to perform medium processing on a transfer medium, subsequent to or prior to ejection of ink. The ink is configured to form an image to be transferred from the transfer medium to a transfer-receival medium. The control method includes causing the process portion to perform one of the medium processing of forming additional information on the transfer medium in a non-transfer mode, or the medium processing of implementing a restriction procedure on the additional information formed on the transfer medium, or the medium processing of implementing an image transfer procedure on the image formed on the transfer medium, and not implementing an information transfer procedure on the additional information formed on the transfer medium. The non-transfer mode is a mode in which the additional information is not transferred from the transfer medium to the transfer-receival medium in a transfer process of transferring the image from the transfer medium to the transfer-receival medium. The restriction procedure is a procedure that restricts the information transfer procedure from being implemented on the additional information formed on the transfer medium. The information transfer procedure is a procedure for transferring the additional information from the transfer medium to the transfer-receival medium in the transfer process. The image transfer procedure is a procedure for transferring the image from the transfer medium to the transfer-receival medium in the transfer process.

The second aspect, like the first aspect, contributes to suppressing the additional information from being transferred from the transfer medium to the transfer-receival medium in the transfer process.

A third aspect of the present disclosure relates to a transfer medium. The transfer medium includes a base material. The transfer medium includes a receival layer. The receival layer is a layer disposed on the base material and being a layer subsequent to or prior to ink being ejected thereon. The ink is configured to form an image to be transferred to a transfer-receival medium. The transfer medium includes additional information. The additional information is formed on the transfer medium in a non-transfer mode, or a restriction procedure is implemented on the additional information, or an image transfer procedure is implemented on the image formed by the ink received by the receival layer, and an information transfer procedure is not implemented on the additional information. The non-transfer mode is a mode in which, in a transfer process of transferring the image formed by the ink received by the receival layer from the transfer medium to the transfer-receival medium, the additional information is not transferred from the transfer medium to the transfer-receival medium. The restriction procedure is a procedure that restricts the information transfer procedure from being implemented on the additional information. The information transfer procedure is a procedure for transferring the additional information from the transfer medium to the transfer-receival medium in the transfer process. The image transfer procedure is a procedure for transferring the image from the transfer medium to the transfer-receival medium in the transfer process.

The third aspect, like the first aspect, contributes to suppressing the additional information from being transferred from the transfer medium to the transfer-receival medium in the transfer process.

### BRIEF DESCRIPTION OF DRAWINGS

FIG. 1 is a schematic plan view of a print system.

FIG. 2 is a schematic perspective view of a sheet cutter and an inversion tray.

FIG. 3 is a schematic perspective view of a transfer film.

FIG. 4 is a block diagram illustrating an electrical configuration of the print system.

FIG. 5 is a flowchart illustrating a main processing.

FIG. 6 is a diagram illustrating a transition of a state of a medium when the main processing is performed.

FIG. 7 is diagram illustrating corresponding data.

FIG. 8 is a schematic plan view of a sheet cutter.

FIG. 9 is a schematic left side view of the sheet cutter.

FIG. 10 is a block diagram illustrating an electrical configuration of a control board 10 and the sheet cutter.

FIG. 11 is a schematic side view of a transfer file piece.

FIG. 12 is a schematic side view of a transfer file piece.

FIG. 13 is a schematic side view of a transfer file piece.

FIG. 14 is a schematic perspective view of a heat press device.

FIG. 15 is a schematic side view of the heat press device during execution of a heat press operation.

FIG. 16 is a schematic side view of a transfer file piece.

FIG. 17 is a schematic plan view of a transfer file piece.

### DESCRIPTION

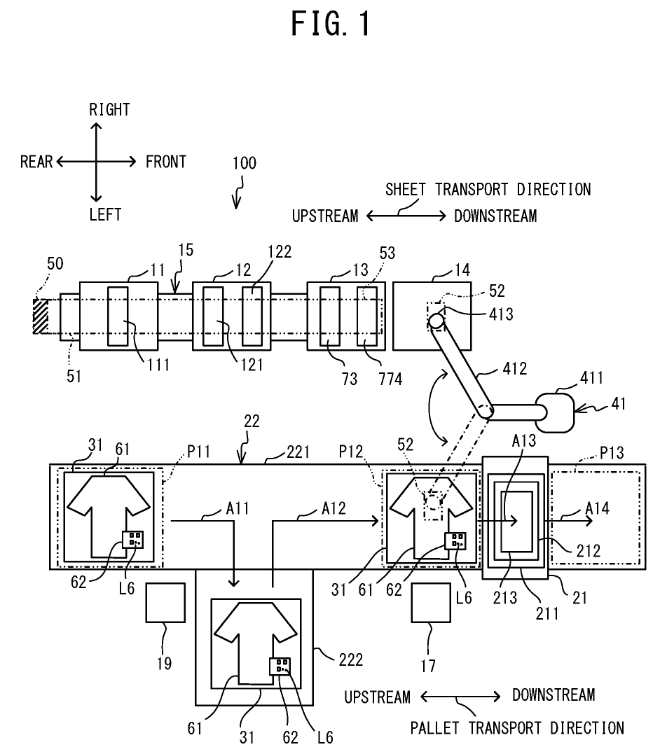

A print system 100 according to an embodiment of the present disclosure will be described with reference to the drawings. The print system 100 shown in FIG. 1 is a system that performs Direct to Film printing. Hereinafter, the Direct to Film printing will be referred to as “DTF printing”.

The DTF printing is a method for printing an image on a transfer-receival medium. In the DTF printing, an image formation process, an adhesive layer formation process, and a transfer process are executed in the order of the image formation process, the adhesive layer formation process, and the transfer process.

In the image formation process, the image is formed on a transfer medium. In the adhesive layer formation process, an adhesive layer is formed on the image formed on the transfer medium. In the transfer process, the image is transferred from the transfer medium to the transfer-receival medium. In this way, the transfer-receival medium on which the image is printed is created.

The configuration of the print system 100 will be described with reference to FIG. 1. The left direction, the right direction, the upward direction, the downward direction, a depth direction on paper, and a front direction on paper are, respectively, the rear direction, the front direction, the right direction, the left direction, the downward direction, and the upward direction of the print system 100.

Hereinafter, the rear direction of the print system 100 will also be referred to as “upstream in a sheet transport direction”. The front direction of the print system 100 will be referred to as “downstream in the sheet transport direction”. The sheet transport direction is a direction in which a transfer film 51 to be described later is transported by a sheet cutter 13.

Hereinafter, the rear direction of the print system 100 will also be referred to as “upstream in a pallet transport direction”. The front direction of the print system 100 will be referred to as “downstream in the pallet transport direction”. The pallet transport direction is a direction in which a pallet 31 to be described later is transported by a main transport path 221.

In FIG. 1, in order to facilitate understanding of the description, in plan view, upstream in the sheet transport direction and upstream in the pallet transport direction are the same direction. In contrast, in plan view, downstream in the sheet transport direction and upstream in the pallet transport direction may be the same direction. In plan view, the sheet transport direction and the pallet transport direction may intersect each other.

The print system 100 includes a printer 11, a powder shaker 12, the sheet cutter 13, an inversion tray 14, and a sheet support base 15.

In the sheet transport direction, the printer 11, the powder shaker 12, the sheet cutter 13, and the inversion tray 14 are arranged from upstream to downstream in the order of the printer 11, the powder shaker 12, the sheet cutter 13, and the inversion tray 14.

The sheet support base 15 extends from upstream in the sheet transport direction to downstream in the sheet transport direction. The sheet support base 15 passes through the printer 11 and the powder shaker 12. The sheet support base 15 extends to the sheet cutter 13 after passing through the powder shaker 12.

A film roll 50 is disposed upstream of the sheet support base 15 in the sheet transport direction. The film roll 50 is a supply source of the transfer film 51. The transfer film 51 is wound around the film roll 50. The transfer film 51 is a type of transfer medium.

The transfer film 51 pulled out from the film roll 50 is placed on the sheet support base 15. In other words, the sheet support base 15 supports the transfer film 51 pulled out from the film roll 50.

The transfer film 51 is transported on the sheet support base 15 from upstream in the sheet transport direction to downstream in the sheet transport direction. Thus, the transfer film 51 passes through the printer 11, the powder shaker 12, and the sheet cutter 13, in the order of the printer 11, the powder shaker 12, and the sheet cutter 13.

The printer 11 is used in the image formation process. The printer 11 is an inkjet printer. The printer 11 includes an inkjet head 111.

The inkjet head 111 is a plate. The inkjet head 111 includes nozzles. The nozzles are openings. The inkjet head 111 is configured to eject ink from the nozzles.

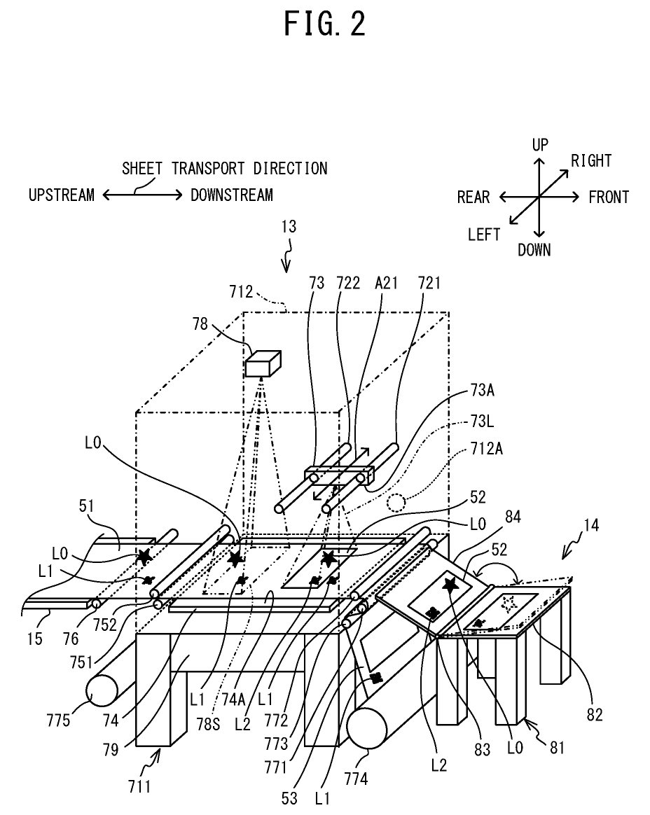

In the present embodiment, the printer 11 ejects the ink from the nozzles of the inkjet head 111 onto the transfer film 51 placed on the sheet support base 15, and forms an ink layer on the transfer film 51. The ink layer forms an image L0 shown in FIG. 2. Thus, the printer 11 forms the image L0 on the transfer film 51 placed on the sheet support base 15. Note that, in the example shown in FIG. 2, the image L0 has a star shape.

In the present embodiment, using the ink layer, the printer 11 forms primary additional information L1 shown in FIG. 2 on the transfer film 51, in addition to the image L0. The primary additional information L1 is additional information formed on the transfer film 51 by the printer 11.

In the present embodiment, the additional information represents one or more types of display by which a computer or a user can recognize a specific meaning. The user includes an operator or an administrator of the print system 100, for example. For example, the additional information may be the display by which the computer can recognize the specific meaning. The additional information may be the display by which the user can recognize the specific meaning. The additional information may be a combination of the display by which the computer can recognize the specific meaning, and the display by which the user can recognize the specific meaning.

An example of the display by which the computer can recognize the specific meaning is code information. The code information is encoded information, such as one-dimensional code information or two-dimensional code information, for example. An example of the one-dimensional code information is a barcode. An example of the two-dimensional code information is a QR code (registered trademark).

An example of the display by which the computer can recognize the specific meaning, and an example of the display by which the user can recognize the specific meaning is character information. The character information is information including a character string or a graphic that has meaning itself, or conveys a concept. The character string is a date, a lot number, or an image ID, for example.

The additional information includes information utilized by the print system 100 or the user when transferring the image from the transfer medium to the transfer-receival medium. The additional information includes identification information, for example. In the present embodiment, the additional information represents the image ID.

The image ID is used for distinguishing the image associated with the image ID from other images. For example, the image ID may be used to identify the image to be transferred from the transfer medium to the transfer-receival medium. The image ID may be used to identify the image that has been transferred from the transfer medium to the transfer-receival medium. The image ID may be used to identify the transfer-receival medium to which the image is to be transferred from the transfer medium.

The powder shaker 12 is used in the adhesive layer formation process. The powder shaker 12 is an adhesive layer formation device. The powder shaker 12 includes an application spray 121 and a heater 122.

The application spray 121 has a nozzle. The nozzle is an opening. Powder is sprayed from the nozzle of the application spray 121. The powder includes an adhesive component.

The heater 122 is configured to heat the air inside the powder shaker 12. The heater 122 melts the powder by generating heat.

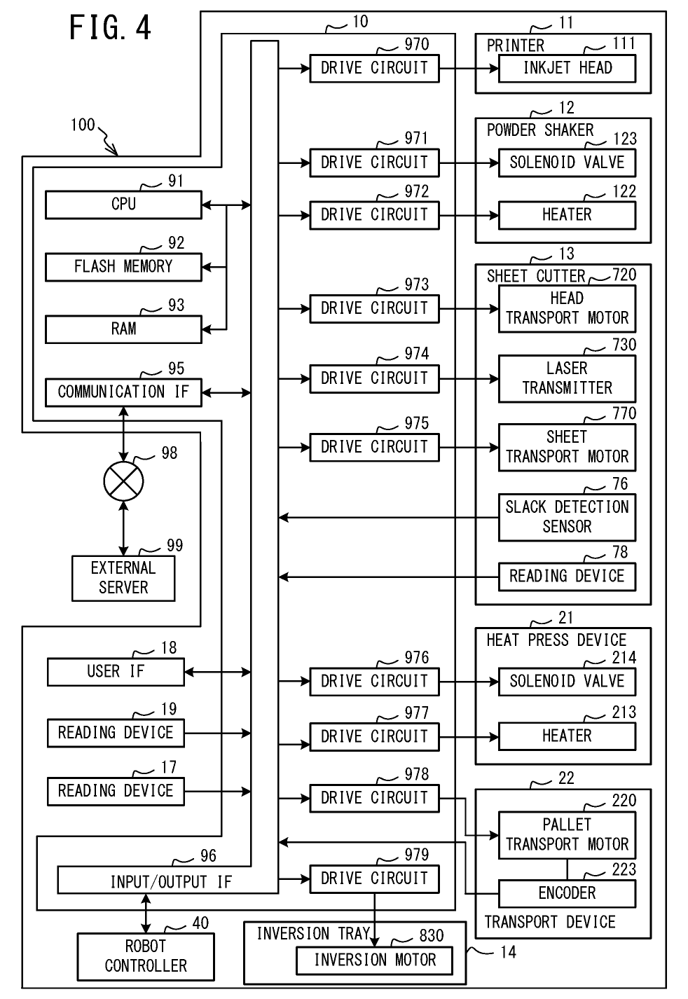

In the present embodiment, when compressed air is supplied to the application spray 121 by opening an solenoid valve 123 shown in FIG. 4, the powder is sprayed from the nozzle of the application spray 121. When the supply of the compressed air to the application spray 121 is stopped by closing the solenoid valve 123 shown in FIG. 4, the spraying of the powder from the application spray 121 stops.

In the present embodiment, the powder shaker 12 is configured to spray the powder from the nozzle of the application spray 121 onto the transfer film 51 placed on the sheet support base 15, and apply the powder to the transfer film 51. On the transfer film 51, the applied powder attaches to the image L0 and the primary additional information L1. The powder does not easily attach to sections of the transfer film 51 on which the image L0 and the primary additional information L1 are not formed.

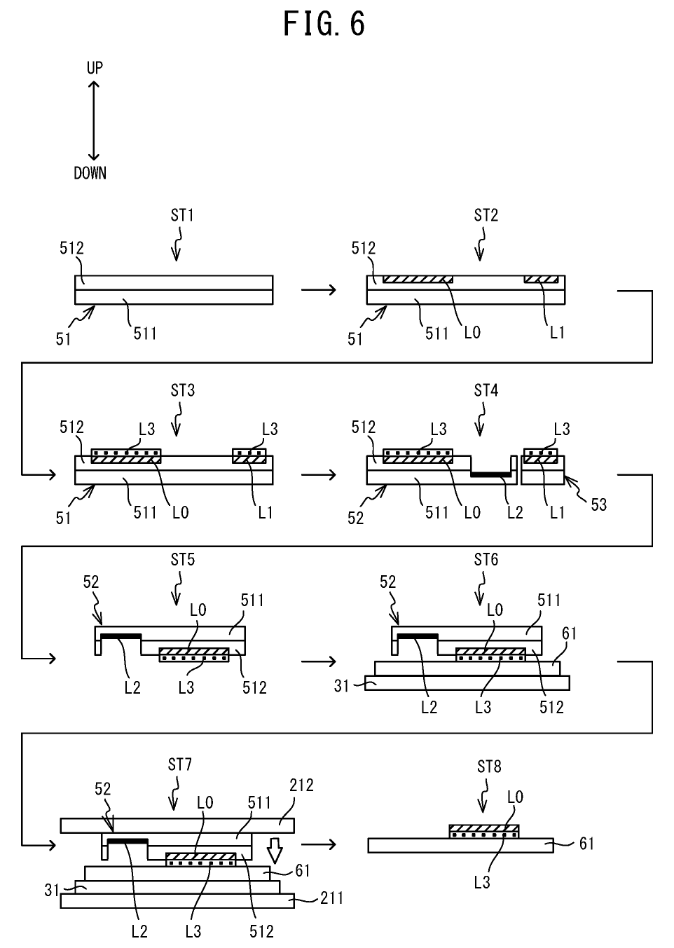

In a state in which the powder has been applied to the image L0 and the primary additional information L1, the powder shaker 12 causes the heater 122 to generate the heat, and melts the powder applied to the transfer film 51. In the transfer film 51, the melted powder forms an adhesive layer L3 shown in FIG. 6 on the image L0 and on the primary additional information L1.

The sheet cutter 13 is a laser device. The sheet cutter 13 includes a laser head 73 and a winding roller 774. The laser head 73 emits laser light 73L. The winding roller 774 winds up the transfer film 51.

In the present embodiment, the sheet cutter 13 is configured to irradiate the laser light 73L from the laser head 73 onto the transfer film 51 placed on the sheet support base 15, and process the transfer film 51. For example, using the laser light 73L, the laser head 73 cuts the transfer film 51 into a transfer film piece 52 and a discard film 53. For example, using the laser light 73L, the laser head 73 forms secondary additional information L2 shown in FIG. 2 on the transfer film 51.

The secondary additional information L2 is additional information formed on the transfer film 51 by the sheet cutter 13.

The sheet cutter 13 winds up the transfer film 51 using the winding roller 774, and transports the transfer film 51. In this way, the transfer film 51 is transported from the film roll 50 toward the winding roller 774. The sheet cutter 13 will be described in detail later.

The inversion tray 14 receives the transfer film piece 52 from the sheet cutter 13. The inversion tray 14 vertically inverts the transfer film piece 52 received from the sheet cutter 13. The inversion tray 14 will be described in detail later.

The print system 100 includes a transport device 22, a reading device 19, a reading device 17, and a heat press device 21.

The transport device 22 is a belt conveyor. The pallet 31 is placed on the transport device 22. In other words, the transport device 22 is configured to support the pallet 31. The transport device 22 is configured to transport the pallet 31.

The transport device 22 includes the main transport path 221, and a pallet stocker 222.

The main transport path 221 extends from upstream in the pallet transport direction to downstream in the pallet transport direction. The main transport path 221 passes through the heat press device 21.

The main transport path 221 transports the pallet 31 placed on the main transport path 221 from upstream in the pallet transport direction to downstream in the pallet transport direction.

The pallet stocker 222 is disposed upstream of the heat press device 21 in the pallet transport direction. The pallet stocker 222 is branched off from the main transport path 221. The pallet stocker 222 is a buffer until the pallet 31 is transported to the heat press device 21.

The pallet 31 is a plate. A transfer-receival shirt 61 is placed on the pallet 31. In other words, the pallet 31 is configured to support the transfer-receival shirt 61.

The transfer-receival shirt 61 is a type of the transfer-receival medium. The transfer-receival medium may be a medium other than the transfer-receival shirt 61. The transfer-receival medium may be fabric, paper, a plastic film, metal, or glass.

A tag 62 is attached to the transfer-receival shirt 61. The tag 62 may be attached by sewing to the transfer-receival shirt 61, or may be adhered to the transfer-receival shirt 61. The tag 62 may be attached to the pallet 31. Target additional information L6 is formed on the tag 62. The target additional information L6 is additional information formed on the tag 62.

The main transport path 221 includes a set position P11, a placement transfer position P12, and a discharge position P13.

The set position P11 is a position further upstream than the heat press device 21 in the pallet transport direction. For example, the set position P11 is a position further upstream in the pallet transport direction than a branch point between the main transport path 221 and the pallet stocker 222. In the present embodiment, the set position P11 is a position furthermost upstream on the main transport path 221 in the pallet transport direction.

The placement transfer position P12 is a position further upstream than the heat press device 21 in the pallet transport direction. In the present embodiment, the placement transfer position P12 is a position, in the pallet transport direction, between the branch point between the main transport path 221 and the pallet stocker 222 and the heat press device 21.

The discharge position P13 is a position further downstream than the heat press device 21 in the pallet transport direction. In the present embodiment, the discharge position P13 is a position furthermost downstream on the main transport path 221 in the pallet transport direction.

The reading device 19 is disposed further upstream than the pallet stocker 222 in the pallet transport direction. In the present embodiment, the reading device 19 is disposed close to the set position P11.

In the present embodiment, the reading device 19 is a code reader. The reading device 19 is a camera, for example. The reading device 19 is configured to read the target additional information L6 in a state in which the pallet 31 is disposed at the set position P11.

The reading device 17 is disposed between the pallet stocker 222 and the heat press device 21 in the pallet transport direction. In the present embodiment, the reading device 17 is disposed close to the placement transfer position P12.

In the present embodiment, the reading device 17 is a code reader. The reading device 17 is a camera, for example.

In the present embodiment, in a state in which the pallet 31 is disposed at the placement transfer position P12, using a placement transfer robot 41, the transfer film piece 52 is disposed on the transfer-receival shirt 61 placed on the pallet 31. In this state, the target additional information L6 attached to the tag 62 of the transfer-receival shirt 61 and the secondary additional information L2 formed on the transfer film piece 52 are present on the pallet 31. In a state in which the pallet 31 is disposed at the placement transfer position P12 and the transfer film piece 52 is on the transfer-receival shirt 61, the reading device 17 is configured to read the target additional information L6 and the secondary additional information L2.

The heat press device 21 is used in the transfer process. The heat press device 21 is a transfer device. The heat press device 21 includes a fixed plate 211, a movable plate 212, and a heater 213.

The fixed plate 211 extends in the front-rear direction and the left-right direction. The movable plate 212 is disposed above or below the fixed plate 211. In the present embodiment, the movable plate 212 is disposed above the fixed plate 211. The movable plate 212 faces the fixed plate 211 in the up-down direction.

The movable plate 212 is disposed so as to be able to move in the up-down direction. The movable plate 212 is configured to move in the up-down direction as a result of the opening and closing of an solenoid valve 214 shown in FIG. 4. More specifically, when compressed air is supplied to the movable plate 212 by the opening and closing of the solenoid valve 214 shown in FIG. 4, the movable plate 212 moves closer to the fixed plate 211 in the up-down direction. When the compressed air is evacuated from the movable plate 212 by the opening and closing of the solenoid valve 214 shown in FIG. 4, the movable plate 212 moves away from the fixed plate 211 in the up-down direction.

The heater 213 is disposed at one or both of the fixed plate 211 and the movable plate 212. The heater 213 is configured to heat one or both of the fixed plate 211 and the movable plate 212.

A heat press operation by the heat press device 21 will be described. The heat press operation is an operation in which the heat press device 21 presses the transfer film piece 52 onto the transfer-receival shirt 61 using the fixed plate 211 and the movable plate 212.

In the present embodiment, the pallet 31 is disposed between the fixed plate 211 and the movable plate 212. The transfer-receival shirt 61 is placed on the pallet 31. The transfer film piece 52 is placed on the transfer-receival shirt 61. In this state, the heat press device 21 causes the movable plate 212 to move closer to the fixed plate 211 in the up-down direction. In this way, the transfer film piece 52 is pressed against the transfer-receival shirt 61 between the fixed plate 211 and the movable plate 212.

The heat press device 21 performs the heat press operation as described above. When the heat press operation is performed, the image L0 is transferred from the transfer film piece 52 to the transfer-receival shirt 61.

The print system 100 includes the placement transfer robot 41. The placement transfer robot 41 is an industrial robot. The placement transfer robot 41 includes a base 411, an arm 412, and a gripper 413.

The base 411 is disposed at a lower portion of the placement transfer robot 41. One end of the arm 412 is supported by the base 411. The gripper 413 is supported at the other end of the arm 412.

The gripper 413 grips the transfer film piece 52, or releases the gripped transfer film piece 52. In the present embodiment, the gripper 413 is a suction gripper.

The placement transfer robot 41 operates the arm 412 and the gripper 413 in the state in which the pallet 31 is disposed at the placement transfer position P12. In this way, the placement transfer robot 41 picks up the transfer film piece 52 from the inversion tray 14 and moves it onto the transfer-receival shirt 61 placed on the pallet 31.

The sheet cutter 13 and the inversion tray 14 will be described with reference to FIG. 2. The sheet cutter 13 includes a base 711 and a housing 712.

The base 711 is disposed at a lower portion of the sheet cutter 13. The base 711 supports the housing 712 from below.

The housing 712 is fixed to the upper end of the base 711. In FIG. 2, in order to describe the internal structure of the housing 712, the housing 712 is shown using dotted lines.

The housing 712 includes a cover and a main frame. The housing 712 has a square cylindrical shape. The housing 712 is open in the front-rear direction.

The housing 712 includes a connection port 712A. The connection port 712A is disposed in the right surface of the housing 712. The connection port 712A is an opening.

A duct for dust collection is connected to the connection port 712A from the outside of the housing 712. For example, dust may be generated by the laser light 73L being irradiated onto the transfer film 51. The duct for dust collection discharges the generated dust to the outside of the housing 712.

The sheet cutter 13 includes guide rails 721 and 722, and the laser head 73.

The guide rails 721 and 722 are fixed to the housing 712. The guide rails 721 and 722 extend in the left-right direction. The guide rails 721 and 722 support the laser head 73 such that the laser head 73 can move in the left-right direction.

The laser head 73 has a rectangular cuboid shape. The laser head 73 includes a nozzle surface 73A. The nozzle surface 73A is the lower surface of the laser head 73.

The nozzle surface 73A includes a nozzle. The nozzle is an opening. The laser head 73 emits the laser light 73L downward from the nozzle.

The laser head 73 is coupled to a head transport motor 720 shown in FIG. 4. The laser head 73 is transported in the left-right direction along the guide rails 721 and 722 by the driving of the head transport motor 720, as shown by an arrow A21.

The sheet cutter 13 includes a support plate 74. The support plate 74 is disposed below the laser head 73. The support plate 74 is fixed to a lower portion of the housing 712. The support plate 74 extends in the front-rear direction and the left-right direction.

The support plate 74 includes a support surface 74A. The support surface 74A is the upper surface of the support plate 74. The support surface 74A faces the nozzle surface 73A in the up-down direction. The support surface 74A supports the transfer film 51.

The support surface 74A has a specific color. In a case where a reading device 78 to be described later reads the primary additional information L1, the support surface 74A is the background to the primary additional information L1. Thus, a color that allows the reading device 78 to easily read the primary additional information L1 is preferably employed as the specific color. A material of the support plate 74 and the color of the support surface 74A are preferably determined while taking into account an amount of reflected light reflected by the support surface 74A.

The sheet cutter 13 includes tension rollers 751 and 752. Each of the tension rollers 751 and 752 is disposed further upstream than the laser head 73 in the sheet transport direction. In the present embodiment, each of the tension rollers 751 and 752 is disposed close to the upstream end of the support plate 74 in the sheet transport direction.

The tension roller 752 is disposed above and close to the tension roller 751. The tension rollers 751 and 752 face each other in the up-down direction.

Each of the tension rollers 751 and 752 extends in the left-right direction. Each of the tension rollers 751 and 752 is rotatably supported by the main frame of the housing 712.

The tension rollers 751 and 752 apply tension to the transfer film 51 in the upstream direction in the sheet transport direction, between the tension rollers 751 and 752. In this way, the tension rollers 751 and 752 suppress the occurrence of wrinkles or slack in the transfer film 51. The tension rollers 751 and 752 guide the transfer film 51 to the support plate 74. When the transfer film 51 is transported from upstream to downstream in the sheet transport direction, each of the tension rollers 751 and 752 rotates in accordance with the transport of the transfer film 51.

The sheet cutter 13 includes a slack detection sensor 76. The slack detection sensor 76 is disposed further upstream than the tension rollers 751 and 752 in the sheet transport direction. The slack detection sensor 76 is configured to detect the presence or absence of slack in the transfer film 51. The type of the slack detection sensor 76 is not limited to a specific type. In the present embodiment, the slack detection sensor 76 is an optical sensor.

The sheet cutter 13 includes transport rollers 771 and 772, a tension roller 773, and the winding roller 774.

Each of the transport rollers 771 and 772 is disposed further downstream than the laser head 73 in the sheet transport direction. In the present embodiment, each of the transport rollers 771 and 772 is disposed close to the downstream end of the support plate 74 in the sheet transport direction.

The transport roller 772 is disposed above and close to the transport roller 771. The transport rollers 771 and 772 face each other in the up-down direction.

Each of the transport rollers 771 and 772 extends in the left-right direction. Each of the transport rollers 771 and 772 is rotatably supported by the main frame of the housing 712.

The transport rollers 771 and 772 clamp the transfer film 51 therebetween. In this way, the transport rollers 771 and 772 are configured to prescribe a transport path of the transfer film 51.

The tension roller 773 is disposed diagonally to the rear of and below the transport roller 771. The tension roller 773 extends in the left-right direction. The tension roller 773 is rotatably supported by the main frame of the housing 712.

The tension roller 773 comes into contact with the discard film 53. In this way, the tension roller 773 is configured to prescribe the transport path of the discard film 53. In the present embodiment, the tension roller 773 prescribes the transport path of the discard film 53 such that the discard film 53 that has passed in front of the transport roller 771 moves toward the rear from the transport roller 771. The tension roller 773 applies tension to the discard film 53. The tension roller 773 guides the discard film 53 to the winding roller 774.

The winding roller 774 is disposed further downstream than the transport rollers 771 and 772 in the sheet transport direction. In the present embodiment, the winding roller 774 is disposed diagonally to the front of and below the transport rollers 771 and 772.

The winding roller 774 extends in the left-right direction. The winding roller 774 is rotatably supported by the main frame of the housing 712.

The downstream end of the discard film 53 in the sheet transport direction is connected to the outer peripheral surface of the winding roller 774. In other words, the downstream end of the transfer film 51 in the sheet transport direction is connected to the outer peripheral surface of the winding roller 774.

The transport roller 771 and the winding roller 774 are respectively coupled to a sheet transport motor 770 shown in FIG. 4, via a power transmission mechanism. The power transmission mechanism includes a gear, a pulley or a belt, for example.

The transport rollers 771 and 772 and the winding roller 774 are rotated by the driving of the sheet transport motor 770. As a result of the transport rollers 771 and 772 rotating, the discard film 53 is fed to the winding roller 774 via the tension roller 773, and the transfer film piece 52 is fed to the inversion tray 14. The transport roller 772 rotates in accordance with the rotation of the transport roller 771.

The winding roller 774 winds up the discard film 53 by rotating. In this way, the transport rollers 771 and 772 and the winding roller 774 transport the transfer film 51 from upstream to downstream in the sheet transport direction.

The sheet cutter 13 includes the reading device 78. The reading device 78 is disposed higher than the support plate 74. The reading device 78 is disposed further upstream than the laser head 73 in the sheet transport direction. The reading device 78 is disposed further downstream than the tension rollers 751 and 752 in the sheet transport direction. The reading device 78 is fixed to the housing 712.

In the present embodiment, the reading device 78 is a code reader. The reading device 78 is a camera, for example. The reading device 78 reads the primary additional information L1 in a state in which the primary additional information L1 is disposed in a reading range 78S.

The reading range 78S is formed, in the sheet transport direction, over a range from the tension rollers 751 and 752 to the laser head 73. The reading range 78S of the reading device 78 is formed on the support plate 74. In other words, the reading range 78S of the reading device 78 is formed inside the sheet cutter 13.

The sheet cutter 13 includes a control box 79. The control box 79 is disposed below the housing 712. The control box 79 is fixed to the lower surface of the housing 712. The control box 79 houses a control board 10 shown in FIG. 4.

The sheet cutter 13 includes a feed roller 775. The feed roller 775 is disposed further upstream than the tension rollers 751 and 752 in the sheet transport direction.

The feed roller 775 extends in the left-right direction. The feed roller 775 is rotatably supported by the main frame of the housing 712. In the present embodiment, the feed roller 775 is not used.

The inversion tray 14 is disposed further downstream than the transport rollers 771 and 772 in the sheet transport direction.

The inversion tray 14 includes a base 81, a fixed plate 82, a shaft 83, and a movable plate 84.

The base 81 is disposed at a lower portion of the inversion tray 14. The base 81 supports the fixed plate 82 from below.

The fixed plate 82 is fixed to the upper end of the base 81. The fixed plate 82 extends in the front-rear direction and the left-right direction.

The shaft 83 is disposed at the rear end of the fixed plate 82. The shaft 83 extends in the left-right direction. The shaft 83 is rotatably supported by the fixed plate 82.

The shaft 83 is coupled to an inversion motor 830 shown in FIG. 4. The shaft 83 is rotated by the driving of the inversion motor 830.

A first end of the movable plate 84 is fixed to the shaft 83. The movable plate 84 moves between a receival position and an inverted position as a result of the rotation of the shaft 83. In FIG. 2, the movable plate 84 disposed at the receival position is illustrated using solid lines. In FIG. 2, the movable plate 84 disposed at the inverted position is shown using virtual lines.

In the present embodiment, the movable plate 84 is configured to move from the receival position to the inverted position as a result of the shaft 83 rotating in the clockwise direction in left side view. The movable plate 84 is configured to move from the inverted position to the receival position as a result of the shaft 83 rotating in the counterclockwise direction in left side view.

In a case where the movable plate 84 is disposed at the receival position, a second end of the movable plate 84 is disposed further to the rear than the first end of the movable plate 84. In the case where the movable plate 84 is disposed at the receival position, the second end of the movable plate 84 is disposed higher than the first end of the movable plate 84. Thus, in the case where the movable plate 84 is disposed at the receival position, the second end of the movable plate 84 is the rear end and the upper end of the movable plate 84. As a result, in the case where the movable plate 84 is disposed at the receival position, in side view, the movable plate 84 extends to be inclined downward from the rear toward the front.

In the case where the movable plate 84 is disposed at the receival position, the second end of the movable plate 84 is disposed diagonally to the front of and below the transport roller 771, at a position close to the transport roller 771.

In the case where the movable plate 84 is disposed at the receival position, the movable plate 84 receives the transfer film piece 52 from the transport rollers 771 and 772.

In a case where the movable plate 84 is disposed at the inverted position, the second end of the movable plate 84 is disposed above and close to the front end of the fixed plate 82. In other words, in the case where the movable plate 84 is disposed at the inverted position, the movable plate 84 overlaps the fixed plate 82 from above.

The inversion tray 14 is configured to move the movable plate 84 from the receival position to the inverted position, and vertically inverts the orientation of the transfer film piece 52.

A cutting procedure by the sheet cutter 13 will be described. The cutting procedure is an operation in which the sheet cutter 13 cuts the transfer film 51 using the laser light 73L.

In the cutting procedure, the sheet cutter 13 causes a laser transmitter 730 shown in FIG. 4 to transmit the laser light 73L at a high power. The laser transmitter 730 transmits the laser light 73L. The laser light 73L transmitted by the laser transmitter 730 is supplied to the laser head 73.

The laser head 73 irradiates the laser light 73L transmitted at the high power onto the transfer film 51 from the nozzle. In this way, the sheet cutter 13 cuts the transfer film 51 by the cutting procedure.

The laser transmitter 730 is not limited to a specific type. In the present embodiment, the laser transmitter 730 transmits the laser light 73L using a gas. The gas used by the laser transmitter 730 is not limited to a specific type. In the present embodiment, the gas used by the laser transmitter 730 is carbon dioxide.

In the present embodiment, the high power is a magnitude at which a hole is opened in the transfer film 51 when the laser light 73L is irradiated onto the transfer film 51 from the laser head 73. In other words, the high power is a magnitude at which the transfer film 51 is cut when the laser light 73L is irradiated onto the transfer film 51 from the laser head 73.

The sheet cutter 13 performs the cutting procedure while transporting the transfer film 51 relative to the laser head 73 in the front-rear direction and the left-right direction. In the present embodiment, the sheet cutter 13 performs the cutting procedure while transporting the laser head 73 back and forth in the left-right direction, and transporting the transfer film 51 from upstream to downstream in the sheet transport direction.

In the present embodiment, the sheet cutter 13 cuts the transfer film 51 into the transfer film piece 52 and the discard film 53 by the cutting procedure.

The transfer film piece 52 includes a region including the image L0 and the secondary additional information L2, of the transfer film 51. The transfer film piece 52 does not include the primary additional information L1.

The discard film 53 is a section of the transfer film 51 that is not cut out as the transfer film piece 52. The discard film 53 includes the primary additional information L1. Thereafter, the discard film 53 may be discarded.

In the present embodiment, the sheet cutter 13 cuts out the transfer film piece 52 from the transfer film 51. Thus, the discard film 53 is a section of the transfer film 51 that is not cut out by the sheet cutter 13. The discard film 53 remains in a state of being connected to a section of the transfer film 51 further upstream in the sheet transport direction than the laser head 73.

A laser mark forming procedure by the sheet cutter 13 will be described. The laser mark forming procedure is an operation in which the sheet cutter 13 forms a laser mark in the transfer film 51 using the laser light 73L. In the present embodiment, the sheet cutter 13 forms the secondary additional information L2 in the transfer film 51 by the laser mark forming procedure.

In the laser mark forming procedure, the sheet cutter 13 causes the laser transmitter 730 to transmit the laser light 73L at a low power. The magnitude of the low power is lower than the magnitude of the high power.

The laser head 73 irradiates the laser light 73L transmitted at the low power onto the transfer film 51 from the nozzle. In this way, the sheet cutter 13 forms the laser mark in the transfer film 51 by the laser mark forming procedure.

In the present embodiment, the low power is a magnitude at which a hole is not opened in the transfer film 51 when the laser light 73L is irradiated onto the transfer film 51 from the laser head 73. In other words, the low power is a magnitude at which the transfer film 51 is indented when the laser light 73L is irradiated onto the transfer film 51 from the laser head 73. In other words, the low power is a magnitude at which the transfer film 51 is not cut when the laser light 73L is irradiated onto the transfer film 51 from the laser head 73. The low power is a magnitude at which the transfer film 51 changes color when the laser light 73L is irradiated onto the transfer film 51 from the laser head 73.

The sheet cutter 13 performs the laser mark forming procedure while transporting the transfer film 51 relative to the laser head 73 in the front-rear direction and the left-right direction. In the present embodiment, the sheet cutter 13 performs the laser mark forming procedure while transporting the laser head 73 back and forth in the left-right direction, and transporting the transfer film 51 from upstream to downstream in the sheet transport direction.

As described above, in the present embodiment, the cutting procedure and the laser mark forming procedure are performed using the common laser head 73.

The transport path of the transfer film 51 in the sheet cutter 13 will be described. The transfer film 51 is transported by the rotation of the transport rollers 771 and 772, and of the winding roller 774. In this case, the transfer film 51 passes from the rear to the front above the slack detection sensor 76.

The transfer film 51 that has passed the slack detection sensor 76 passes from the rear to the front between the tension rollers 751 and 752. The transfer film 51 that has passed between the tension rollers 751 and 752 passes from the rear to the front over the support plate 74.

The transfer film 51 that has passed over the support plate 74 passes from the rear to the front between the transport rollers 771 and 772. When the transfer film 51 passes between the transport rollers 771 and 772, the transfer film piece 52 cut out from the transfer film 51 is passed from the transport rollers 771 and 772 to the movable plate 84.

On the other hand, the transfer film 51 that has passed between the transport rollers 771 and 772 moves downward from the rear toward the front along the outer peripheral surfaces of the transport rollers 771 and 772. The transfer film 51 that has passed between the transport rollers 771 and 772 is the discard film 53.

The discard film 53 transported along the transport roller 771 passes from the front to the rear above the tension roller 773. The discard film 53 that has passed the tension roller 773 moves downward along the outer peripheral surface of the tension roller 773. The discard film 53 that has been transported along the tension roller 773 is wound up by the winding roller 774.

An inverting operation by the inversion tray 14 will be described. As described above, when the transfer film 51 passes between the transport rollers 771 and 772, the transfer film piece 52 cut out from the transfer film 51 is passed from the transport rollers 771 and 772 to the movable plate 84. In this case, the transfer film piece 52 is placed on the movable plate 84.

In a case where the movable plate 84 has moved from the receival position to the inverted position in the state in which the transfer film piece 52 is placed on the movable plate 84, the transfer film piece 52 is passed from the movable plate 84 to the fixed plate 82. In this case, the orientation of the transfer film piece 52 is vertically inverted. In the present embodiment, the orientation of the transfer film piece 52 being vertically inverted will be referred to as “the transfer film piece 52 is inverted”.

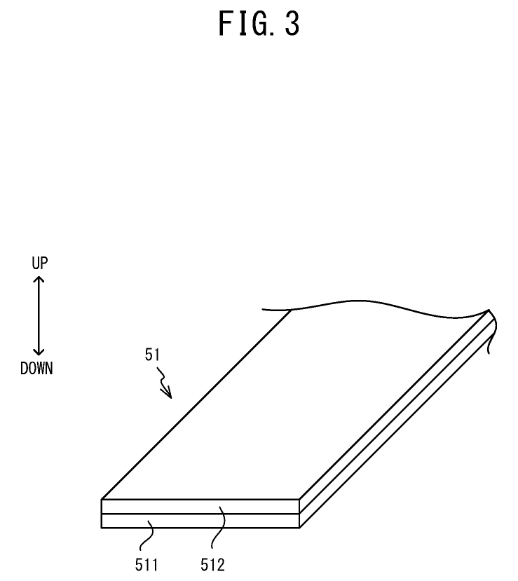

The transfer film 51 will be described with reference to FIG. 3. The transfer film 51 has a long shape. The transfer film 51 has a thin film shape. The transfer film 51 includes a base material 511 and a receival layer 512.

The base material 511 is thin paper or a plastic film. The base material 511 may be a composite film made of thin paper and a plastic film.

The receival layer 512 is a layer laminated on the base material 511. The receival layer 512 includes a component for coagulating ink. The component for coagulating the ink is a polyvalent metal salt, for example. The receival layer 512 may further include a cationic urethane resin, a cationic fixing agent, and a filler, for example.

The receival layer 512 is transmissive to visible light. Further, the layer receival layer 512 is configured to coagulate the ink applied to the receival layer 512. In this way, an ink layer is fixed to the receival layer 512.

In the transfer film 51, a release layer may be laminated between the base material 511 and the receival layer 512.

Hereinafter, of the transfer film 51, a surface configured by the base material 511 will be referred to as a “front surface”. Of the transfer film 51, a surface configured by the receival layer 512 will be referred to as a “back surface”.

In the present embodiment, the transfer film 51 is placed on the sheet support base 15 in a state in which the base material 511 is oriented downward and the receival layer 512 is oriented upward. In other words, the transfer film 51 is placed on the sheet support base 15 in a state in which the front surface is oriented downward and the back surface is oriented upward. In this way, in the printer 11, the receival layer 512 faces the inkjet head 111. Thus, the ink ejected from the nozzles of the inkjet head 111 lands on the receival layer 512 in the transfer film 51.

The receival layer 512 receives the landed ink. In other words, the landed ink is fixed to the receival layer 512. As a result, in the transfer film 51, the ink layer is formed on the receival layer 512. In other words, in the transfer film 51, the image L0 is formed on the receival layer 512.

In the present embodiment, the transfer film 51 is transparent. Note that the transfer film 51 may be semi-transparent, or may be opaque. Semi-transparent refers to a degree of light transmittance at which the reading device 78 can read the primary additional information L1 or the secondary additional information L2 formed on one surface of the transfer film 51, from the other surface of the transfer film 51.

The electrical configuration of the print system 100 will be described with reference to FIG. 4. The print system 100 includes a control board 10. The control board 10 includes a CPU 91, a flash memory 92, and a RAM 93. The CPU 91, the flash memory 92, and the RAM 93 are electrically connected to each other. The CPU 91 controls the print system 100.

The flash memory 92 is a non-volatile memory. The flash memory 92 stores various types of information. For example, programs are stored in the flash memory 92.

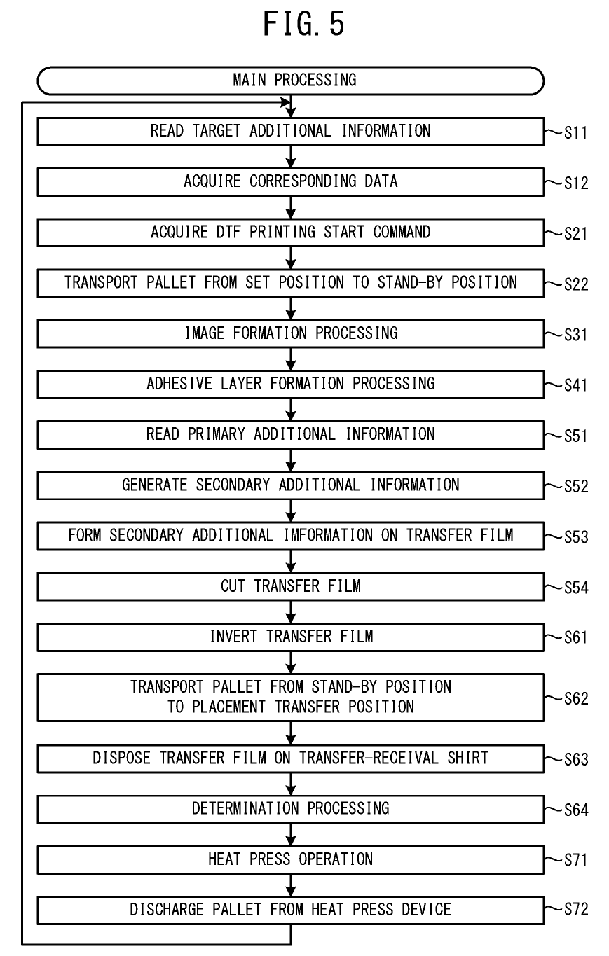

The programs consist of computer-readable instructions. The programs are executed by the CPU 91. When the programs are executed by the CPU 91, the programs instruct the CPU 91 to perform various types of processing. The programs include a control program for executing main processing to be described later and shown in FIG. 5.

The RAM 93 temporarily stores data. For example, the data includes flags used in the main processing, information acquired, specified, calculated, or determined in the main processing.

In the present embodiment, an interface is denoted as “IF”. The CPU 91 is electrically connected to drive circuits 970, 971, 972, 973, 974, 975, 976, 977, 978, and 979 via an input/output IF 96.

The drive circuit 970 is electrically connected to the inkjet head 111. The drive circuit 970 is configured to eject the ink from the nozzles of the inkjet head 111 in accordance with control by the CPU 91.

The drive circuit 971 is electrically connected to the solenoid valve 123. The drive circuit 971 is configured to open and close the solenoid valve 123 in accordance with control by the CPU 91.

The drive circuit 972 is electrically connected to the heater 122. The drive circuit 972 is configured to cause the heater 122 to generate heat in accordance with control by the CPU 91.

The drive circuit 973 is electrically connected to the head transport motor 720. The drive circuit 973 is configured to drive the head transport motor 720 in accordance with control by the CPU 91.

The drive circuit 974 is electrically connected to the laser transmitter 730. The drive circuit 974 is configured to transmit the laser light 73L at the high power or the low power from the laser transmitter 730 in accordance with control by the CPU 91.

The drive circuit 975 is electrically connected to the sheet transport motor 770. The drive circuit 975 is configured to drive the sheet transport motor 770 in accordance with control by the CPU 91.

The drive circuit 976 is electrically connected to the solenoid valve 214. The drive circuit 976 is configured to open and close the solenoid valve 214 in accordance with control by the CPU 91.

The drive circuit 977 is electrically connected to the heater 213. The drive circuit 977 is configured to cause the heater 213 to generate heat in accordance with control by the CPU 91.

The drive circuit 978 is electrically connected to a pallet transport motor 220. The drive circuit 978 is configured to drive the pallet transport motor 220 in accordance with control by the CPU 91.

The drive circuit 979 is electrically connected to the inversion motor 830. The drive circuit 979 is configured to drive the inversion motor 830 in accordance with control by the CPU 91.

The CPU 91 is electrically connected to the slack detection sensor 76, the reading device 78, an encoder 223, a robot controller 40, a user IF 18, the reading device 19, the reading device 17, and a communication IF 95, via the input/output IF 96.

The slack detection sensor 76 is configured to output a signal to the CPU 91 indicating the presence or absence of slack in the transfer film 51. The CPU 91 performs various types of control based on the signal from the slack detection sensor 76. For example, when the occurrence of slack in the transfer film 51 is detected based on the signal from the slack detection sensor 76, the CPU 91 performs error notification.

The reading device 78 reads information. The reading device 78 is configured to output a signal to the CPU 91 indicating the read information. Based on the signal from the reading device 78, the CPU 91 analyzes the information.

The encoder 223 is fixed to the pallet transport motor 220. The encoder 223 is configured to detect a rotation angle of the pallet transport motor 220. The encoder 223 outputs a signal to the CPU 91 indicating the detected rotation angle. Based on the signal from the encoder 223, the CPU 91 identifies the position of the pallet 31 on the transport device 22.

The robot controller 40 is mounted in the placement transfer robot 41. The robot controller 40 includes a CPU, a flash memory, and a RAM, for example. The robot controller 40 is configured to control the placement transfer robot 41 in accordance with control by the CPU 91. The robot controller 40 outputs a control result to the CPU 91.

The user IF 18 is configured to receive an operation by the user. The user IF 18 is configured to output a signal to the CPU 91 corresponding to the received operation. The CPU 91 performs various type of control based on the signal from the user IF 18.

The reading device 19 is configured to read information. The reading device 19 is configured to output a signal to the CPU 91 indicating the read information. Based on the signal from the reading device 19, the CPU 91 analyzes the information.

The reading device 17 is configured to read information. The reading device 17 is configured to output a signal to the CPU 91 indicating the read information. Based on the signal from the reading device 17, the CPU 91 analyzes the information.

The communication IF 95 is connected to an external server 99 via a network 98. The CPU 91 and the external server 99 are configured to communicate with each other via the communication IF 95.

Main processing will be described with reference to FIG. 5. When a power supply to the control board 10 is turned on, the CPU 91 starts the main processing by reading and operating the control program from the flash memory 92.

The CPU 91 controls the DTF printing by executing the main processing. In the present embodiment, by executing the main processing, the CPU 91 automatically performs the image formation process, the adhesive layer formation process, and the transfer process, in the order of the image formation process, the adhesive layer formation process, and the transfer process.

As shown by a state ST1 in FIG. 6, at a start time point of the main processing, the image L0 and so on are not formed on the transfer film 51.

In the present embodiment, a case is assumed in which the main processing is started in a state in which the pallet 31 is disposed at the set position P11 shown in FIG. 1. The user places the transfer-receival shirt 61 on the pallet 31 at the set position P11.

As shown in FIG. 5, when the main processing is started, the CPU 91 reads the target additional information L6 shown in FIG. 1, via the reading device 19 shown in FIG. 1 (S11). In the processing at S11, the CPU 91 identifies the image ID from the read target additional information L6.

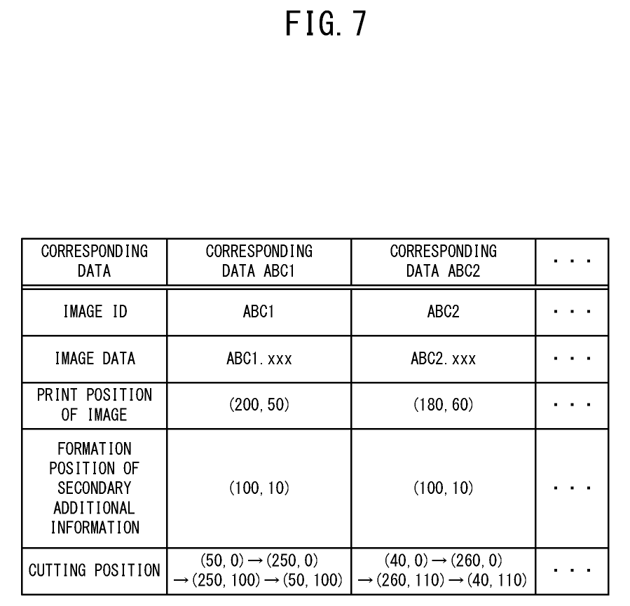

The CPU 91 acquires corresponding data shown in FIG. 7 from the external server 99 shown in FIG. 4 (S12).

As shown in FIG. 7, the external server 99 shown in FIG. 4 stores the corresponding data for each of the image IDs. In the example shown in FIG. 7, the external server 99 stores corresponding data ABC1 corresponding to an image ID “ABC1”, and corresponding data ABC2 corresponding to an image ID “ABC2”.

The corresponding data includes image data, data representing a print position of the image L0, data representing a formation position of the secondary additional information L2, and data representing a cutting position.

The image data represents the image L0 and the primary additional information L1 to be printed on the transfer film 51 by the printer 11. In other words, the image data represents the image L0 associated with the image ID, and the primary additional information L1 representing the image ID.

The print position of the image L0 is a position at which the image L0 is to be printed on the transfer film 51. The data representing the print position of the image L0 represents the print position of the image L0 in the front-rear direction and the left-right direction using coordinates of the printer 11.

For example, print ranges are extracted. The print ranges include a range of the image L0 and a range of the primary additional information L1. The print range has a square shape or a rectangular shape, for example. The print position of the image L0 is set using one of four corners of the extracted print range as a print start position of the image L0. Note that a print start position of the primary additional information L1 can be identified using the print start position of the image L0 as a reference.

The formation position of the secondary additional information L2 is a position at which the secondary additional information L2 is to be formed on the transfer film 51 by the laser mark forming procedure by the sheet cutter 13. The data representing the formation position of the secondary additional information L2 represents the formation position of the secondary additional information L2 in the front-rear direction and the left-right direction using coordinates of the sheet cutter 13. The formation position of the secondary additional information L2 is determined using a formation position of the primary additional information L1 as a reference. In the present embodiment, at a time of generating the corresponding data, the formation position of the secondary additional information L2 is determined in advance using the formation position of the primary additional information L1 as the reference.

For example, a range of the secondary additional information L2 is extracted. The range of the secondary additional information L2 has a square shape or a rectangular shape, for example. The formation position of the secondary additional information L2 is set using one of four corners of the extracted range of the secondary additional information L2 as a formation start position of the secondary additional information L2. The extracted range of the secondary additional information L2 is determined so as not to overlap with the range of the image L0 and the range of the primary additional information L1.

The cutting position is a trajectory of the laser light 73L on the transfer film 51 when the sheet cutter 13 cuts the transfer film 51 by the cutting procedure. The data representing the cutting position represents the cutting position in the front-rear direction and the left-right direction using the coordinates of the sheet cutter 13. The cutting position is set such that the transfer film piece 52 includes the image L0 and the secondary additional information L2.

In the processing at S12 shown in FIG. 5, the CPU 91 notifies the external server 99 of the image ID identified by the processing at S11. When the external server 99 receives the image ID from the CPU 91, the external server 99 transmits, to the print system 100, the corresponding data corresponding to the notified image ID. The CPU 91 receives the corresponding data transmitted from the external server 99. For example, when the image ID identified by the processing at S11 is “ABC1”, in the processing at S12, the CPU 91 acquires the corresponding data ABC1 corresponding to the image ID “ABC1”.

After checking the corresponding data acquired by the CPU 91 in the processing at S12, the user inputs a command to start the DTF printing to the print system 100, via the user IF 18 shown in FIG. 4. In this case, the CPU 91 acquires the command to start the DTF printing via the user IF 18 (S21).

The CPU 91 transports the pallet 31 from the set position P11 shown in FIG. 1 to the pallet stocker 222 shown in FIG. 1 (S22). In this case, the pallet 31 is transported along an arrow A11 shown in FIG. 1.

The CPU 91 performs image formation processing (S31). In the image formation processing (S31), the CPU 91 controls the inkjet head 111 based on the image data and the data representing the print position of the image L0 acquired by the processing at S12. The inkjet head 111 ejects the ink from the nozzles onto the transfer film 51.

By the ejected ink, the image L0 represented by the image data is printed at the position represented by the print position of the image L0 on the transfer film 51. The primary additional information L1 represented by the image data is printed at a predetermined position on the transfer film 51. The predetermined position is a position at which the primary additional information L1 does not overlap the image L0 in plan view.

As shown by a state ST2 shown in FIG. 6, when the image formation processing (S31) is performed, the image L0 and the primary additional information L1 are formed on the receival layer 512 in the transfer film 51. A process in which the image formation processing (S31) is performed is the image formation process.

Note that the adhesive layer L3 is formed in the primary additional information L1 in adhesive layer formation processing. Thus, a reading accuracy of the primary additional information L1 by the reading device 78 may possibly deteriorate due to the adhesive layer L3. In the present embodiment, the primary additional information L1 has a size with which the reading device 78 can read the primary additional information L1 in a state in which the adhesive layer L3 is formed in the primary additional information L1.

As shown in FIG. 5, subsequent to the processing at S31, the CPU 91 performs the adhesive layer formation processing (S41). In the adhesive layer formation processing (S41), the CPU 91 transports the transfer film 51 shown in FIG. 1 and disposes the image L0 and the primary additional information L1 formed in the image formation processing (S31) inside the powder shaker 12 shown in FIG. 1. In this state, the CPU 91 controls the solenoid valve 123 and the heater 122 shown in FIG. 4.

By opening and closing the solenoid valve 123, the application spray 121 shown in FIG. 1 sprays the powder onto the transfer film 51. The heater 122 shown in FIG. 1 generates the heat and thus melts the powder. In this way, as shown by a state ST3 shown in FIG. 6, the adhesive layer L3 is formed on the image L0 and on the primary additional information L1.

The receival layer 512, the image L0, and the adhesive layer L3 are arranged from the bottom to the top in the order of the receival layer 512, the image L0, and the adhesive layer L3. The receival layer 512, the primary additional information L1, and the adhesive layer L3 are arranged from the bottom to the top in the order of the receival layer 512, the primary additional information L1, and the adhesive layer L3. A process in which the adhesive layer formation processing (S41) is performed is the adhesive layer formation process.

As shown in FIG. 5, subsequent to the adhesive layer formation processing (S41), the CPU 91 reads the primary additional information L1 (S51) via the reading device 78 shown in FIG. 2, while transporting the transfer film 51 shown in FIG. 1. In this case, the reading device 78 reads the primary additional information L1 via the adhesive layer L3. The CPU 91 identifies the image ID from the read primary additional information L1.

Subsequent to the adhesive layer formation processing (S41), in the processing at S51, the CPU 91 reads the primary additional information L1 prior to the cutting procedure being performed in processing at S54 to be described later. Based on the read primary additional information L1, the CPU 91 can identify the formation position of the primary additional information L1. Based on the identified formation position of the primary additional information L1, the CPU 91 can identify the formation position of the secondary additional information L2 associated with the image ID. The primary additional information L1 is utilized in the generation of the secondary additional information L2.

The CPU 91 generates the secondary additional information L2 (S52) represented by the image ID identified by the processing at S51.

The CPU 91 forms the secondary additional information L2 on the transfer film 51 shown in FIG. 2, by the laser mark forming procedure by the sheet cutter 13 shown in FIG. 2 (S53).

In the present embodiment, the CPU 91 controls the laser head 73 shown in FIG. 2, based on the data representing the formation position of the secondary additional information L2 acquired by the processing at S12. The CPU 91 causes the laser transmitter 730 shown in FIG. 4 to transmit the laser light 73L at the low power. The laser head 73 irradiates the laser light 73L at the low power from the nozzle onto the transfer film 51.

In this way, as shown by a state ST4 shown in FIG. 6, the secondary additional information L2 generated by the processing at S52 is formed, on the transfer film 51, at the formation position of the secondary additional information L2 by the irradiated low power laser light 73L.

In the present embodiment, the formation position of the secondary additional information L2 is a position different from the position of the transfer film 51 at which the primary additional information L1 is formed. In other words, on the transfer film 51, the secondary additional information L2 is formed at a position not overlapping the primary additional information L1 in plan view.

In the present embodiment, the formation position of the secondary additional information L2 is a position different from the position of the transfer film 51 at which the image L0 is formed. In other words, on the transfer film 51, the secondary additional information L2 is formed at a position not overlapping the image L0 in plan view.

In the present embodiment, the processing at S53 is performed on the transfer film 51 onto which the ink has been ejected by the inkjet head 111.

As shown in FIG. 5, subsequent to the processing at S53, the CPU 91 cuts the transfer film 51 shown in FIG. 2 by the cutting procedure by the sheet cutter 13 shown in FIG. 2 (S54).

In the present embodiment, the CPU 91 controls the laser head 73 shown in FIG. 2, based on the data representing the cutting position acquired by the processing at S12. The CPU 91 causes the laser transmitter 730 shown in FIG. 4 to transmit the laser light 73L at the high power.

The laser head 73 irradiates the high power laser light 73L from the nozzle onto the transfer film 51. In this way, as shown by the state ST4 in FIG. 6, the transfer film 51 is cut into the transfer film piece 52 and the discard film 53 by the irradiated high power laser light 73L.

As shown in FIG. 5, subsequent to the processing at S54, using the inverting operation by the inversion tray 14 shown in FIG. 2, the CPU 91 inverts the transfer film piece 52 shown in FIG. 2 (S61).

In the present embodiment, the CPU 91 transports the transfer film 51 and passes the transfer film piece 52 from the sheet cutter 13 to the inversion tray 14. In this case, the transfer film piece 52 is disposed on the movable plate 84. In this state, the CPU 91 performs the inverting operation. The transfer film piece 52 is inverted in this way, as shown by a state ST5 in FIG. 6.

As shown in FIG. 5, subsequent to the processing at S61, the CPU 91 transports the pallet 31 from the pallet stocker 222 shown in FIG. 1 to the placement transfer position P12 shown in FIG. 1 (S62). In this case, the pallet 31 is transported along an arrow A12 shown in FIG. 1.

The CPU 91 outputs, to the robot controller 40 shown in FIG. 4, a command to place the transfer film piece 52 shown in FIG. 1 on the transfer-receival shirt 61 shown in FIG. 1 (S63).

When the robot controller 40 receives the command from the CPU 91, the robot controller 40 controls the placement transfer robot 41 shown in FIG. 1, and passes the transfer film piece 52 from the inversion tray 14 to the transfer-receival shirt 61. In the processing at S62, the pallet 31 is disposed at the placement transfer position P12 shown in FIG. 1. Thus, as shown by a state ST6 in FIG. 6, the transfer film piece 52 is disposed on the transfer-receival shirt 61.

As shown in FIG. 5, subsequent to the processing at S63, the CPU 91 performs determination processing (S64). In the determination processing (S64), the CPU 91 reads the secondary additional information L2 and the target additional information L6 on the pallet 31, using the reading device 17 shown in FIG. 1. The CPU 91 determines whether the image ID represented by the target additional information L6 is the same as the image ID represented by the secondary additional information L2.

For example, in a case where the image ID represented by the target additional information L6 is different from the image ID represented by the secondary additional information L2, the CPU 91 stops the main processing. In this case, the CPU 91 may perform error notification. In a case where the image ID represented by the target additional information L6 and the image ID represented by the secondary additional information L2 are the same as each other, the CPU 91 advances the processing to processing at S71.

The CPU 91 transports the pallet 31 from the placement transfer position P12 shown in FIG. 1 to the heat press device 21 shown in FIG. 1, and performs the heat press operation using the heat press device 21 (S71). In this case, the pallet 31 is transported along an arrow A13 shown in FIG. 1.

By the processing at S71, as shown by a state ST7 in FIG. 6, the transfer film piece 52 is pressed against the transfer-receival shirt 61 between the fixed plate 211 and the movable plate 212. In this way, the image L0 is transferred from the transfer film piece 52 to the transfer-receival shirt 61. The process in which the processing at S71 is performed is the transfer process. In the transfer process, the image L0 is transferred from the transfer film piece 52 to the transfer-receival shirt 61 by the transfer film piece 52 being pressed against the transfer-receival shirt 61 by the heat press device 21.

The secondary additional information L2 is formed by the laser mark forming procedure by the sheet cutter 13, and is not formed using the ink. Thus, the secondary additional information L2 is not transferred from the transfer film piece 52 to the transfer-receival shirt 61.

As shown in FIG. 5, the CPU 91 discharges the pallet 31 from the heat press device 21 shown in FIG. 1 to the discharge position P13 shown in FIG. 1 (S72). In this case, the pallet 31 is transported along an arrow A14 shown in FIG. 1. The CPU 91 returns the processing to the processing at S11.

As shown by a state ST8 in FIG. 6, when the transfer film piece 52 is peeled from the transfer-receival shirt 61, the image L0 is formed on the transfer-receival shirt 61. The primary additional information L1 and the secondary additional information L2 are both not formed on the transfer-receival shirt 61.

Main operations and effects of the above-described embodiment will be described.

In the above-described embodiment, the CPU 91 controls the laser head 73 and forms the secondary additional information L2 on the transfer film 51 in a non-transfer mode (S53). The non-transfer mode is a mode in which, in the transfer process, the secondary additional information L2 is not transferred from the transfer film piece 52 to the transfer-receival shirt 61. In the above-described embodiment, the non-transfer mode is the laser mark forming procedure using the laser light 73L. In other words, the non-transfer mode is a mode in which ink is not used. Thus, the sheet cutter 13 contributes to suppressing the secondary additional information L2 from being transferred from the transfer film piece 52 to the transfer-receival shirt 61 in the transfer process.

The transfer film 51 is cut into the transfer film piece 52 and the discard film 53, subsequent to the processing being performed at S53 by the laser head 73 (S54). The transfer film piece 52 includes the image L0. The discard film 53 includes the primary additional information L1. The CPU 91 forms the secondary additional information L2 on the transfer film piece 52 of the transfer film 51 in the non-transfer mode (S53).

When the transfer film 51 is cut into the transfer film piece 52 and the discard film 53, a selection is made as to whether to feed the discard film 53 to the transfer process. In the above-described embodiment, the discard film 53 is wound up by the winding roller 774. In other words, the discard film 53 is not transported to the transfer process. Thus, the primary additional information L1 is not transferred to the transfer-receival shirt 61.

On the other hand, the secondary additional information L2 is formed on the transfer film piece 52. The transfer film piece 52 is transported to the transfer process. For example, the secondary additional information L2 is to be used in a subsequent process. Since the secondary additional information L2 is formed on the transfer film piece 52 in the non-transfer mode, the secondary additional information L2 is not transferred from the transfer film piece 52 to the transfer-receival shirt 61 in the transfer process. Thus, the sheet cutter 13 contributes to suppressing both the secondary additional information L2 and the primary additional information L1 from being transferred from the transfer film 51 to the transfer-receival shirt 61 in the transfer process.

In the above-described embodiment, the secondary additional information L2 is generated based on the image ID identified from the primary additional information L1 (S52). Furthermore, the generated secondary additional information L2 is formed on the transfer film 51. Thus, it can be said that the secondary additional information L2 is formed based on the primary additional information L1.

In this way, the CPU 91 forms the secondary additional information L2 on the transfer film 51 in the non-transfer mode based on the primary additional information L1 (S53), in the state in which the primary additional information L1 is formed on the transfer film 51. Thus, the sheet cutter 13 contributes to forming the secondary additional information L2 by the processing at S53 utilizing the primary additional information L1.

In the above-described embodiment, the transfer film 51 is transparent. Furthermore, the secondary additional information L2 is directly formed on the transfer film 51. In other words, a non-transparent sticker is not interposed between the secondary additional information L2 and the transfer film 51. Thus, the reading device 78 can read the secondary additional information L2 from both surfaces of the transfer film piece 52.

For example, a case is assumed in which the multiple transfer film pieces 52 are present with upward and downward orientations thereof being mixed. Even in this case, the CPU 91 can easily find the transfer film piece 52 that is a search target, from the multiple transfer film pieces 52, based on the reading result from the reading device 78.

Furthermore, the CPU 91 can identify whether the transfer film piece 52 is oriented upward or oriented downward based on the reading result from the reading device 78. Thus, the sheet cutter 13 contributes to suppressing the transfer film piece 52 from being placed on the transfer-receival shirt 61 with an inappropriate orientation.

In the above-described embodiment, the secondary additional information L2 is an example of the “additional information” of the present disclosure. The processing at S53 is an example of the “medium processing” of the present disclosure. The sheet cutter 13 is an example of the “process portion” of the present disclosure. The CPU 91 is an example of the “processor” of the present disclosure.

The heat press device 21 is an example of the “press device” of the present disclosure. The primary additional information L1 is an example of the “separate additional information” of the present disclosure. The region included in the transfer film piece 52 is an example of the “image region” of the present disclosure. The region included in the discard film 53 is an example of the “information region” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below. The above-described embodiment and each of modified examples may be combined with each other insofar as no contradictions arise.

In the above-described embodiment, a feed roller 755 may be used. A case will be described in which the feed roller 755 is used.

At a stage at which the adhesive layer formation process has ended, the transfer film 51 is wound up into a roll shape. In this way, the film roll 50 is formed. The film roll 50 is mounted to the feed roller 755. In other words, the film roll 50 is mounted to the feed roller 755 in a state in which the image L0 and the primary additional information L1 are formed on the transfer film 51, and the adhesive layer L3 is formed on the image L0 and the primary additional information L1.

A transport path of the transfer film 51 in a case where the feed roller 755 is used will be described. The transfer film 51 is transported as a result of the transport roller 771 and the winding roller 774 rotating. In this case, the transfer film 51 is pulled out from the film roll 50 mounted to the feed roller 755. The transfer film 51 pulled out from the film roll 50 moves upward and passes to the rear of the slack detection sensor 76.

The transfer film 51 that has passed the slack detection sensor 76 moves toward the front along the slack detection sensor 76 and is fed between the tension rollers 751 and 752. The transfer film 51 that has passed through the tension rollers 751 and 752 is supported by the support surface 74A, in a similar manner to the above-described embodiment. Subsequently, the transport path of the transfer film 51 is the same as that of the above-described embodiment. Thus, a description of the subsequent transport path of the transfer film 51 is omitted here.

Note that the transfer film 51 may be transported, on the support plate 74, in a state in which the support surface 74A and the receival layer 512 face each other in the up-down direction. In other words, the transfer film 51 may be transported in a state in which the front surface of the transfer film 51 is oriented upward, and the back surface is oriented downward. In this case, the primary additional information L1 can be read by the reading device 78 in the state in which the transfer film 51 is inverted. Furthermore, the cutting procedure is performed in the state in which the transfer film 51 is inverted.

When the cutting procedure is performed in the state in which the transfer film 51 is inverted, the transfer film piece 52 in an inverted state is created. Thus, the inverting operation by the inversion tray 14 may be omitted. In this case, the function of the inversion tray 14 for inverting the transfer film piece 52 may be omitted.

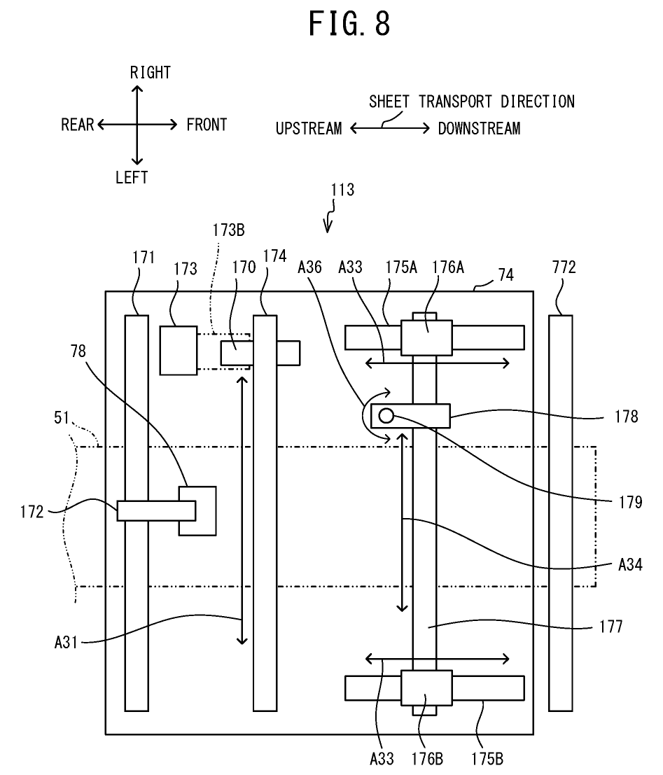

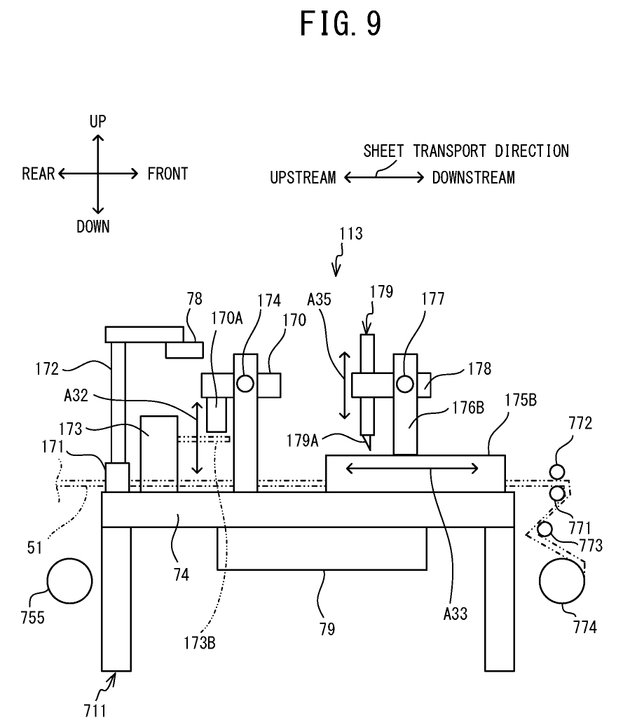

In the above-described embodiment, in place of the sheet cutter 13 shown in FIG. 2, a sheet cutter 113 shown in FIG. 8 and FIG. 9 may be adopted. The sheet cutter 113 will be described with reference to FIG. 8 and FIG. 9. Hereinafter, of the configuration of the sheet cutter 113, the same reference signs will be assigned to the configurations having the same or similar function or shape as that of the configurations of the sheet cutter 13, and a description thereof will be omitted or simplified.

In a similar manner to the sheet cutter 13, the sheet cutter 113 includes the base 711, the support plate 74, the transport rollers 771 and 772, the tension roller 773, the winding roller 774, the reading device 78, the control box 79, and the feed roller 775. In contrast to the sheet cutter 13, the sheet cutter 113 omits the laser head 73. The sheet cutter 113 may omit the other members included in the sheet cutter 13, or may include the other members in the same manner as the sheet cutter 13.

The sheet cutter 113 includes a restriction plate 171 and a support pillar 172.

The restriction plate 171 is disposed at an upstream end of the support plate 74 in the sheet transport direction. The restriction plate 171 extends in the left-right direction.

The restriction plate 171 has a slit. The slit extends through in the front-rear direction between the restriction plate 171 and the support plate 74. As shown in FIG. 9, the transfer film 51 passes from the rear toward the front through the slit of the restriction plate 171.

As shown in FIG. 8 and FIG. 9, the support pillar 172 is disposed at the center of the restriction plate 171 in the left-right direction. The support pillar 172 extends upward from the restriction plate 171.

The reading device 78 is fixed to the upper end of the support pillar 172.

The sheet cutter 113 includes a label printer 173. The label printer 173 is disposed at the right end of the support plate 74.

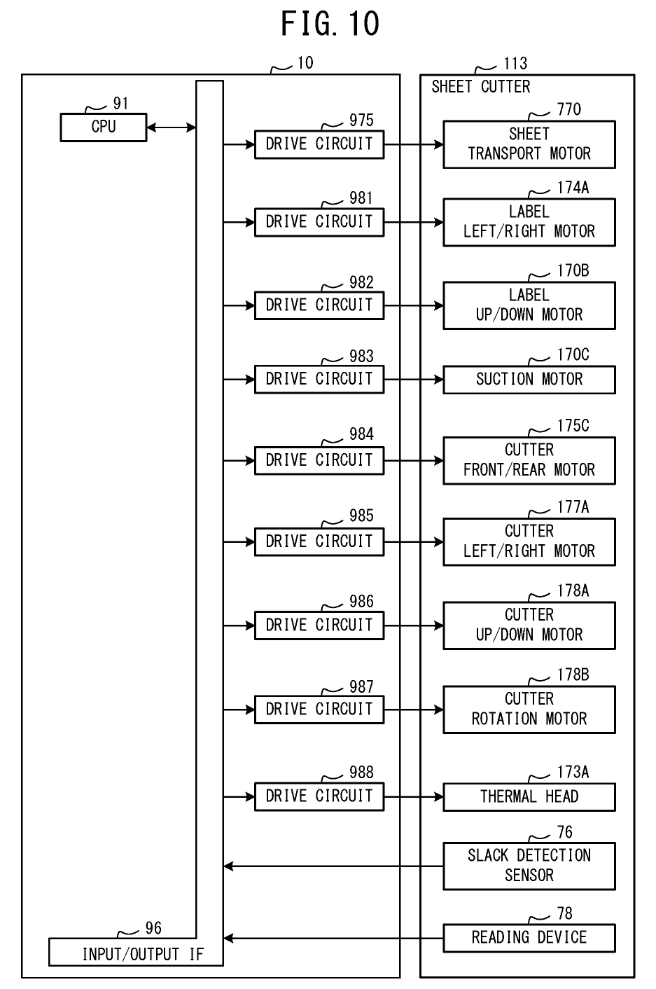

The label printer 173 is a thermal printer, for example. The label printer 173 includes a thermal head 173A shown in FIG. 10. The label printer 173 is configured to create a label sticker 173B by driving the thermal head 173A.

The label sticker 173B may be transparent, may be semi-transparent, or may be opaque. In the present embodiment, semi-transparent refers to a degree of light transmittance at which the reading device 78 can read, from above, the secondary additional information L2 formed on the lower surface of the label sticker 173B.

In a case where the label sticker 173B is opaque, the thermal head 173A prints the secondary additional information L2 on the upper surface of the label sticker 173B. In this case, the secondary additional information L2 may indicate that this is the back surface. In a case where the label sticker 173B is transparent or semi-transparent, the thermal head 173A prints the secondary additional information L2 on the upper surface or the lower surface of the label sticker 173B.

The label sticker 173B includes an adhesive layer. The adhesive layer is disposed on the lower surface of the label sticker 173B.

The sheet cutter 113 includes a guide rail 174 and a support block 170. The guide rail 174 is disposed further downstream than the reading device 78 in the sheet transport direction. The guide rail 174 extends in the left-right direction. The guide rail 174 is disposed higher than the support plate 74.

The support block 170 is supported by the guide rail 174. The support block 170 moves in the left-right direction along the guide rail 174, as indicated by an arrow A31 in FIG. 8, as a result of the driving of a label left/right motor 174A shown in FIG. 10.

The support block 170 includes a gripper 170A. The gripper 170A is supported by the support block 170. The gripper 170A moves in the up-down direction with respect to the support block 170, as indicated by an arrow A32 in FIG. 9, as a result of the driving of a label up/down motor 170B shown in FIG. 10.

The gripper 170A is a suction gripper, for example. The gripper 170A grips the label sticker 173B or releases the gripped label sticker 173B as a result of the driving of a suction motor 170C shown in FIG. 10.

The sheet cutter 113 includes guide rails 175A and 175B, support pillars 176A and 176B, a guide rail 177, a support block 178, and a cutter shaft 179.

The guide rails 175A and 175B are disposed further downstream than the guide rail 174 in the sheet transport direction. The guide rail 175A is fixed to the right end of the support plate 74. The guide rail 175B is fixed to the left end of the support plate 74. The guide rails 175A and 175B extend in the front-rear direction.

The support pillars 176A and 176B extend in the up-down direction. The support pillar 176A is supported by the guide rail 175A. The support pillar 176B is supported by the guide rail 175B. The support pillars 176A and 176B move in the front-rear direction along the guide rails 175A and 175B, as shown by an arrow A33, as a result of the driving of a cutter front/rear motor 175C shown in FIG. 10.

The guide rail 177 extends in the left-right direction. The right end of the guide rail 177 is fixed to the upper end of the support pillar 176A. The left end of the guide rail 177 is fixed to the upper end of the support pillar 176B.

The support block 178 is supported by the guide rail 177. The support block 178 moves in the left-right direction along the guide rail 177, as shown by an arrow A34 in FIG. 8, as a result of the driving of a cutter left/right motor 177A shown in FIG. 10.

The cutter shaft 179 is supported by the support block 178. The cutter shaft 179 moves in the up-down direction with respect to the support block 178, as shown by an arrow A35 in FIG. 9, as a result of the driving of a cutter up/down motor 178A shown in FIG. 10. The cutter shaft 179 rotates in plan view with respect to the support block 178, as shown by an arrow A36 in FIG. 8, as a result of the driving of a cutter rotation motor 178B shown in FIG. 10.

The cutter shaft 179 includes a cutter blade 179A. The cutter blade 179A is disposed at the lower end of the cutter shaft 179. When the transfer film 51 comes into contact with the cutter blade 179A, the transfer film 51 is cut.

The electrical configuration of the sheet cutter 113 and the control board 10 in a case where the sheet cutter 113 is employed will be described with reference to FIG. 10. In FIG. 10, the configuration other than sections indicating an electrical relationship between the CPU 91 and the sheet cutter 113 is omitted.

The control board 10 shown in FIG. 10 differs from the control board 10 shown in FIG. 4 in that the control board 10 shown in FIG. 10 includes drive circuits 981, 982, 983, 984, 985, 986, 987, and 988 in place of the drive circuits 973 and 974 shown in FIG. 4. The drive circuits 981 to 988 are connected to the CPU 91 via the input/output IF 96.

The drive circuit 981 drives the label left/right motor 174A in accordance with control by the CPU 91. The drive circuit 982 drives the label up/down motor 170B in accordance with control by the CPU 91. The drive circuit 983 drives the suction motor 170C in accordance with control by the CPU 91.

The drive circuit 984 drives the cutter front/rear motor 175C in accordance with control by the CPU 91. The drive circuit 985 drives the cutter left/right motor 177A in accordance with control by the CPU 91. The drive circuit 986 drives the cutter up/down motor 178A in accordance with control by the CPU 91. The drive circuit 987 drives the cutter rotation motor 178B in accordance with control by the CPU 91.

The drive circuit 988 causes the thermal head 173A to selectively generate heat in accordance with control by the CPU 91.

Main processing in a case where the sheet cutter 113 is employed will be described. In the main processing in the case where the sheet cutter 113 is employed, the main processing differs from the main processing shown in FIG. 5 at S53 and S54 shown in FIG. 5. Thus, for example, the fact that the image L0 and the primary additional information L1 are formed on the transfer film 51 by the processing at S31 shown in FIG. 5 is the same as in the above-described embodiment.

In the processing at S53, the CPU 91 controls the thermal head 173A and creates the label sticker 173B on which the secondary additional information L2 is printed.

In the processing at S53, the CPU 91 transports the gripper 170A in the left-right direction and the up-down direction, and the suction by the gripper 170A is performed. In this way, the gripper 170A takes the label sticker 173B from the label printer 173.

In the processing at S53, the CPU 91 transports the gripper 170A in the left-right direction and the up-down direction, and stops the suction by the gripper 170A. In this way, the gripper 170A adheres the gripped label sticker 173B to the transfer film 51. The label sticker 173B is adhered at the formation position of the secondary additional information L2 on the transfer film 51.

In the processing at S54, the CPU 91 rotates the cutter shaft 179, and orients the cutter blade 179A in a cutting direction. The CPU 91 transports the cutter shaft 179 in the front-rear direction, the left-right direction, and the up-down direction, and cuts the transfer film 51 into the transfer film piece 52 and the discard film 53.

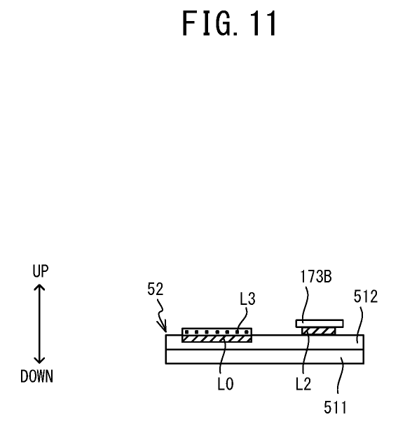

When the main processing is performed in the case in which the sheet cutter 113 is employed, the transfer film piece 52 shown in FIG. 11 is created. In other words, as shown in FIG. 11, the transfer film piece 52 is created in which the label sticker 173B is adhered in an orientation with which the secondary additional information L2 is covered by the label sticker 173B. In other words, the secondary additional information L2 is disposed between the front surface of the label sticker 173B and the transfer film piece 52. In this case, the secondary additional information L2 is not exposed. The receival layer 512, the secondary additional information L2, and the label sticker 173B are arranged from the bottom to the top in the order of the receival layer 512, the secondary additional information L2, and the label sticker 173B.

Subsequently, the transfer film piece 52 shown in FIG. 11 is transported to the transfer process. Note that the discard film 53 on which the primary additional information L1 is formed is not transported to the transfer process. In the transfer process, the label sticker 173B is interposed between the secondary additional information L2 and the transfer-receival shirt 61. Thus, the sheet cutter 113 contributes to suppressing the secondary additional information L2 from being transferred from the transfer film piece 52 to the transfer-receival shirt 61 in the transfer process.

Note that, in the processing at S53, the CPU 91 need not necessarily print the secondary additional information L2 on the label sticker 173B. In this case, in the processing at S53, the CPU 91 may adhere the label sticker 173B on top of the primary additional information L1. In other words, the CPU 91 may adhere, to the primary additional information L1, a sticker on which additional information is not formed. In this case, with respect to the data that is identified based on the secondary additional information L2 in the above-described embodiment, the CPU 91 may identify the data based on the primary additional information L1.

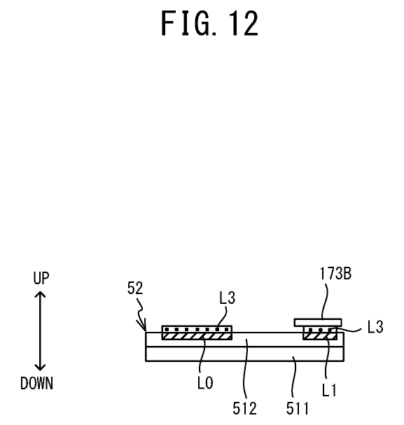

Furthermore, when the sticker on which the additional information is not formed is adhered to the primary additional information L1, in the processing at S54, the CPU 91 may cut the transfer film 51 so as to surround the primary additional information L1 and the image L0. In this case, as shown in FIG. 12, the transfer film piece 52 is formed that includes the image L0, and the primary additional information L1 onto which the label sticker 173B is adhered. The adhesive layer L3 on the image L0 is exposed. The adhesive layer L3 on the primary additional information L1 is not exposed.

As described above, the CPU 91 controls the gripper 170A in the processing at S53, and carries out a restriction procedure on the primary additional information L1 formed on the transfer film 51. Thus, the sheet cutter 113 contributes to suppressing the secondary additional information L2 from being transferred from the transfer film piece 52 to the transfer-receival shirt 61 in the transfer process.

The restriction procedure is a procedure to restrict an information transfer procedure from being carried out on the secondary additional information L2 formed on the transfer film 51. For example, the restriction procedure is the procedure to attach the label sticker 173B to the primary additional information L1.

Note that the sheet cutter 113 need not necessarily include the label printer 173. In this case, the multiple unprinted label stickers 173B may be stacked at a position at which the label printer 173 is disposed.

A timing at which the unprinted label sticker 173B is attached to the primary additional information L1 may be changed. For example, the label sticker 173B may be attached to the primary additional information L1 prior to the adhesive layer formation process. In this case, in the adhesive layer formation process, the adhesive layer L3 is suppressed from being formed on the primary additional information L1.

For example, subsequent to the primary additional information L1 becoming unnecessary, the label sticker 173B may be attached to the primary additional information L1 prior to the transfer process. In this case, the label sticker 173B may be opaque.

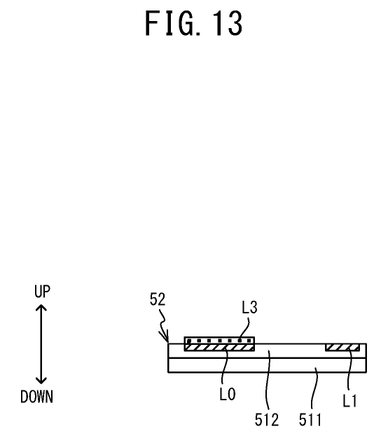

In the above-described embodiment, the CPU 91 may change the adhesive layer formation processing (S41). For example, the CPU 91 controls the application spray 121 and the heater 122, forms the adhesive layer L3 on the image L0, and does not form the adhesive layer L3 on the primary additional information L1. Furthermore, in the processing at S54, the CPU 91 may cut the transfer film 51 so as to surround the primary additional information L1 and the image L0. In this case, as shown in FIG. 13, the transfer film piece 52 including the image L0 on which the adhesive layer L3 is formed, and the primary additional information L1 on which the adhesive layer L3 is not formed is created.

Note that the secondary additional information L2 may be formed on the transfer film 51 or need not necessarily be formed on the transfer film 51.

As described above, the CPU 91 carries out an image transfer procedure on the image L0 formed on the transfer film 51, and does not carry out an information transfer procedure on the primary additional information L1 formed on the transfer film 51. Thus, the sheet cutter 113 contributes to suppressing the primary additional information L1 from being transferred from the transfer film piece 52 to the transfer-receival shirt 61 in the transfer process.

The image transfer procedure is a procedure for transferring the image L0 from the transfer film 51 to the transfer-receival shirt 61 in the transfer process. For example, the image transfer procedure is a procedure that forms the adhesive layer L3 on the image L0.

The information transfer procedure is a procedure for transferring the primary additional information L1 from the transfer film 51 to the transfer-receival shirt 61 in the transfer process. For example, the information transfer procedure is a procedure to form the adhesive layer L3 on the primary additional information L1.

In the above-described embodiment, in place of the powder shaker 12, the printer 11 may form the adhesive layer L3 on the transfer film 51. For example, in the processing at S41, the printer 11 may eject an adhesive from the inkjet head 111 onto the image L0. In this case, the printer 11 need not necessarily discharge the adhesive from the inkjet head 111 onto the primary additional information L1. The adhesive forms an adhesive layer on the image L0. In this case, the powder need not necessarily be used.

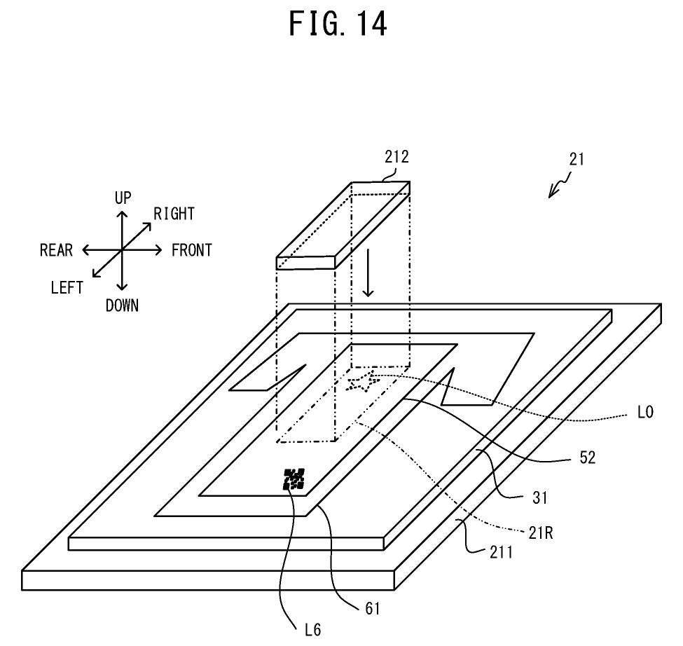

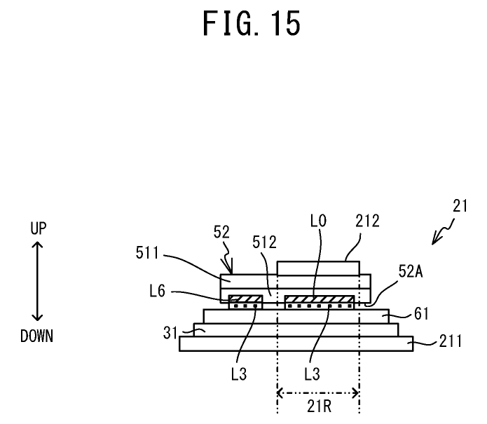

A press region 21R will be defined with reference to FIG. 14 and FIG. 15. The transfer film piece 52 includes a facing surface 52A. In the transfer process, the facing surface 52A faces the transfer-receival shirt 61 in the up-down direction. The facing surface 52A is configured by the receival layer 512.

The press region 21R is included in the facing surface 52A. The press region 21R is a region, of the facing surface 52A, pressed against the transfer-receival shirt 61 by the heat press device 21 in the transfer processing.

In the image laser mark forming procedure (S31), as the non-transfer mode, the CPU 91 may form the primary additional information L1 in a region, of the transfer film piece 52, different from the press region 21R.

The region of the transfer film piece 52 different from the press region 21R includes, for example, a region of the facing surface 52A outside the press region 21R. Furthermore, the region of the transfer film piece 52 different from the press region 21R includes, for example, a surface of the transfer film piece 52 on the opposite side from the facing surface 52A in the up-down direction, for example. The surface of the transfer film piece 52 on the opposite side from the facing surface 52A in the up-down direction is the back surface of the transfer film piece 52. The back surface of the transfer film piece 52 does not come into contact with the transfer-receival shirt 61 in the transfer process.

In this case, the primary additional information L1 is formed in the region of the transfer film piece 52 different from the press region 21R. Thus, the sheet cutter 13 contributes to suppressing the primary additional information L1 from being transferred from the transfer film piece 52 to the transfer-receival shirt 61 in the transfer process.

Furthermore, the primary additional information L1 may include position information of the transfer film piece 52 with respect to the heat press device 21 in the transfer process. The position information of the transfer film piece 52 with respect to the heat press device 21 in the transfer process indicates the position at which the pallet 31 stops, in the pallet transport direction, when the heat press operation is performed.

In the processing at S71, the CPU 91 controls a stop position of the pallet 31, in the pallet transport direction, based on the position information of the transfer film piece 52 with respect to the heat press device 21. In this way, when the transfer film piece 52 is set in the heat press device 21, the primary additional information L1 may be used for positioning the transfer film piece 52 with respect to the heat press device 21.

For example, when the transfer film piece 52 is disposed in the heat press device 21 based on the position information of the transfer film piece 52 with respect to the heat press device 21, the transfer film piece 52 is suppressed from being displaced from a target position with respect to the heat press device 21. Thus, the primary additional information L1 is suppressed from being pressed by the heat press device 21 in the transfer process. As a result, the sheet cutter 13 contributes to suppressing the primary additional information L1 from being transferred from the transfer film piece 52 to the transfer-receival shirt 61 in the transfer process.

Furthermore, the primary additional information L1 may include position information of the image L0 with respect to the transfer film piece 52. In this case, when the transfer film piece 52 is disposed in the heat press device 21 based on the position information of the image L0 with respect to the transfer film piece 52, for example, a situation is suppressed in which the image L0 is not pressed by the heat press device 21. Thus, the sheet cutter 13 contributes to suppressing a transfer defect of the image L0 from the transfer film 51 onto the transfer-receival shirt 61 in the transfer process.

Note that, the secondary additional information L2 may be formed in the region of the transfer film piece 52 different from the press region 21R.

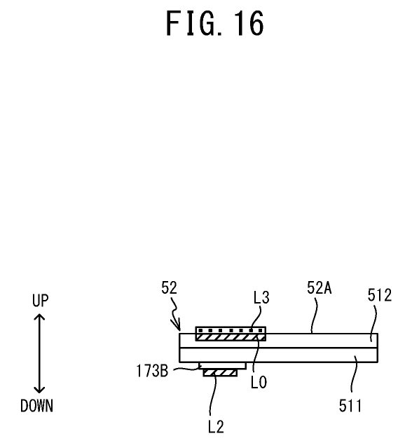

As shown in FIG. 16, the label sticker 173B on which the secondary additional information L2 is printed may be attached to the surface of the transfer film piece 52 on the opposite side to the facing surface 52A in the up-down direction, namely, on the back surface of the transfer film piece 52. In this case, the label sticker 173B is preferably attached to a position overlapping the image L0 as seen in the up-down direction. This is because a margin of the transfer film piece 52 can be made smaller.

In the case where the label sticker 173B on which the secondary additional information L2 is printed is attached to the back surface of the transfer film piece 52, one or both of the label sticker 173B or the base material 511 is preferably opaque. This is in order to suppress a reading failure in which the background of the secondary additional information L2 is read by the reading device 78. In the case where the label sticker 173B is opaque, the base material 511, the label sticker 173B, and the secondary additional information L2 are preferably arranged from top to bottom in the order of the base material 511, the label sticker 173B, and the secondary additional information L2.

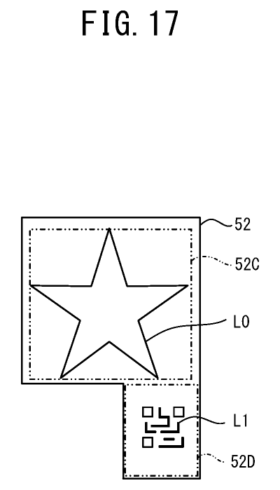

In the above-described embodiment, the transfer film piece 52 may include the primary additional information L1. For example, as shown in FIG. 17, in the processing at S54, the CPU 91 cuts the transfer film 51 such that the transfer film piece 52 includes the image L0 and the primary additional information L1.

The transfer film piece 52 includes a region 52C and a region 52D. The region 52C includes the image L0. The region 52D includes the primary additional information L1. When the transfer film piece 52 shown in FIG. 17 is created, the CPU 91 preferably cuts the transfer film 51 such that, in the transfer film piece 52, the region 52D protrudes from the region 52C.

Note that, in the processing at S54, the transfer film 51 need not necessarily be cut such that the transfer film piece 52 includes the image L0 and the primary additional information L1. In this case, the press region 21R preferably includes the region 52C and does not include the region 52D.

When the transfer film piece 52 shown in FIG. 17 is created, the print system 100 may include a separate sheet cutter from the sheet cutter 13. The separate sheet cutter is disposed close to the placement transfer robot 41.

Subsequent to the placement transfer robot 41 receiving the transfer film piece 52 from the inversion tray 14, and prior to the transfer film piece 52 being disposed on the transfer-receival shirt 61, the transfer film piece 52 is set on the separate sheet cutter.

The separate sheet cutter cuts the transfer film piece 52 into the region 52D and the region 52C. The placement transfer robot 41 grips the film of the region 52C and disposes that film on the transfer-receival shirt 61.

Note that the secondary additional information L2 may be included in either the region including the primary additional information L1 or the region including the image L0. The secondary additional information L2 need not necessarily be formed on the transfer film piece 52.

In the above-described embodiment, the CPU 91 may be connected to some of the devices of the printer 11, the powder shaker 12, the sheet cutter 13, the inversion tray 14, the heat press device 21, the transport device 22, the robot controller 40, and the external server 99. For example, the CPU 91 need not necessarily be connected to the printer 11, the powder shaker 12, the inversion tray 14, the heat press device 21, the transport device 22, the robot controller 40, and the external server 99. In this case, the sheet cutter 13 operates independently.

In a case where the sheet cutter 13 operates independently, in the main processing, the CPU 91 may omit the processing at S11 to S41, and at S61 to S72.

The CPU 91 need not necessarily be connected to the printer 11, the powder shaker 12, the inversion tray 14, the heat press device 21, the transport device 22, and the robot controller 40. In this case, the sheet cutter 13 operates while communicating with the external server 99.

In a case where the sheet cutter 13 operates while communicating with the external server 99, in the main processing, the CPU 91 may omit the processing at S11 to S41, and at S61 to S72. Furthermore, the CPU 91 may acquire the corresponding data from the external server 99, subsequent to reading the primary additional information L1 in the processing at S51. In the processing at S52, the CPU 91 may generate the secondary additional information L2 based on the acquired corresponding data. In this case also, the CPU 91 can be said to generate the secondary additional information L2 based on the primary additional information L1.

In the above-described embodiment, the main transport path 221 may include the multiple placement transfer positions P12. In this case, the placement transfer robot 41 may include a reading device. The secondary additional information L2 may include data to identify any one of the multiple placement transfer positions P12.

The robot controller 40 may identify any one of the multiple placement transfer positions P12 based on the secondary additional information L2 read by the reading device. The robot controller 40 may control the placement transfer robot 41, and may pass the transfer film piece 52 from the inversion tray 14 to the transfer-receival shirt 61 on the pallet 31 disposed at the identified placement transfer position P12.

In the above-described embodiment, the print system 100 may include a drying device. The drying device may be disposed between the printer 11 and the powder shaker 12 in the sheet transport direction. In this case, the DTF printing may include a drying process. The drying process may be performed between the image formation process and the adhesive layer formation process. In the drying process, the CPU 91 may control the drying device so as to dry the primary additional information L1 without drying the ink forming the image L0.

The drying device may include a heat emitting surface. A surface area of the heat emitting surface may be larger than a surface area of the primary additional information L1. For example, the surface area of the heat emitting surface may be of an extent that does not exceed 1.2 times the surface area of the primary additional information L1. The heat emitting surface may have a shape such that all of the primary additional information L1 overlaps the heat emitting surface as seen from above. In other words, in a case where the heat emitting surface and the primary additional information L1 face each other in the up-down direction, the primary additional information L1 does not protrude from the heat emitting surface when seen from above.

In a case where the drying device includes the heat emitting surface, in the drying process, the drying device may cause the heat emitting surface to come close to the primary additional information L1. In this state, the drying device may cause the heat emitting surface to generate heat, and dry the ink forming the primary additional information L1. In the drying process, the drying device may cause the heat emitting surface to come into contact with the primary additional information L1.

In the above-described embodiment, the printer 11 may print the primary additional information L1 on the transfer film 51 in a left-right inverted state. For example, in a case where the primary additional information L1 prior to the left-right inversion is “iipi”, the primary additional information L1 subsequent to the left-right inversion is “iqii”. For example, in a case where the primary additional information L1 is a QR code (registered trademark), it may be determined whether the QR code has been left-right inverted or not using a position of a finder pattern.

In the above-described embodiment, the printer 11 may print white sections of the primary additional information L1 and a margin surrounding the primary additional information L1 using ink. Furthermore, the printer 11 need not necessarily print black sections of the primary additional information L1 using ink.

In the above-described embodiment, the printer 11 may print the black sections of the primary additional information L1 using ink. Furthermore, the printer 11 need not necessarily print the white sections of the primary additional information L1 using ink.

In the above-described embodiment, the printer 11 may print the black sections of the primary additional information L1 using black ink, as first-time black ink printing. Subsequently, the printer 11 may print all of the primary additional information L1 including the margin surrounding the primary additional information L1 using white ink, as white ink printing. Subsequently, the printer 11 may print the black sections of the primary additional information L1 using black ink, as second-time black ink printing.

In the first-time black ink printing, the primary additional information L1 may be left-right inverted. In the second-time black ink printing, the primary additional information L1 need not necessarily be left-right inverted.

Data representing the primary additional information L1 to be printed in the first-time black ink printing, and data representing the primary additional information L1 to be printed in the second-time black ink printing may be different from each other. For example, the primary additional information L1 to be printed in the second-time black ink printing includes data indicating that the reading device 78 is reading the primary additional information L1 from the back surface. The primary additional information L1 to be printed in the first-time black ink printing does not include the data indicating that the reading device 78 is reading the primary additional information L1 from the back surface.

In a case where black sections of the primary additional information L1 to be printed in the first-time black ink printing and black sections of the primary additional information L1 to be printed in the second-time black ink printing overlap each other, the following processing may be performed. Hereinafter, the black sections of the primary additional information L1 to be printed in the first-time black ink printing and the black sections of the primary additional information L1 to be printed in the second-time black ink printing that overlap each other will be simply referred to as “overlapping sections”.

In the white ink printing, the printer 11 prints sections excluding the overlapping sections. In the second-time black ink printing, the printer 11 prints the sections excluding the overlapping sections. In this case, the printer 11 contributes to suppressing a consumption amount of the black ink and the white ink.

In the above-described embodiment, the printer 11 may include five colors of ink, namely, white, yellow, magenta, cyan, and black inks. In this case, the printer 11 may print the primary additional information L1 on the transfer film 51 using ink of any color other than white. The ink of any color other than white is the black ink, for example. In this case, the printer 11 contributes to suppressing the consumption amount of the white ink.

Hereinafter, the yellow, magenta, cyan, and black inks will be referred to as “color inks”.

For example, a background layer may be formed in the image L0 using the white ink. In other words, the image L0 may be formed by, subsequent to ejecting the color ink onto the transfer film 51, ejecting the white ink onto the color ink layer. On the other hand, a background layer need not necessarily be formed in the primary additional information L1 using the white ink. In this way, the printer 11 may have different print settings for the image L0 and for the primary additional information L1.

The printer 11 may print the primary additional information L1 on the transfer film 51 using the white ink also for sections of the primary additional information L1 having a color other than white.

The printer 11 may print the image L0 on the transfer film 51 using a first resolution. The printer 11 may print the primary additional information L1 on the transfer film 51 using a second resolution. The second resolution is lower than the first resolution. In this case, the printer 11 contributes to shortening a time required in the image formation process.

The printer 11 may print the image L0 on the transfer film 51 using a first ink amount. The printer 11 may print the primary additional information L1 on the transfer film 51 using a second ink amount. In a case where a surface area of sections of the image L0 on which ink is to be used and a surface area of sections of the primary additional information L1 on which ink is to be used are the same, the second ink amount is smaller than the first ink amount. In this case, the printer 11 contributes to suppressing the consumption amount of the ink without reducing an image quality of the image L0.

In the above-described embodiment, the printer 11 may print the primary additional information L1 on the transfer film 51 by stippling. The size of one dot formed by the stippling may be of a size with which the powder does not substantially attach to the ink forming the dot.

In the above-described embodiment, the reading device 78 may read the primary additional information L1 from the front surface. The reading device 78 may read the primary additional information L1 from the back surface. The reading device 78 may read the primary additional information L1 from both the front and the back surfaces.

The reading device 17 may read the secondary additional information L2 from the front surface. The reading device 17 may read the secondary additional information L2 from the back surface. The reading device 17 may read the secondary additional information L2 from both the front surface and the back surfaces.

Regardless of whether the primary additional information L1 or the secondary additional information L2 is read from the front surface or the back surface, the CPU 91 may identify the image ID based on the read additional information. The CPU 91 may acquire the corresponding data from the external server 99 based on the identified image ID.

When, for example, the CPU 91 determines that the reading device 17 has read the secondary additional information L2 from the back surface, the CPU 91 may notify the robot controller 40 of the inversion of the transfer film piece 52.

The inversion tray 14 may include an inversion verification device. The inversion verification device is a device similar to the reading device 78, for example. The top of the fixed plate 82 may be the reading range. The inversion verification device may read the secondary additional information L2 in the transfer film piece 52 disposed on the fixed plate 82. The CPU 91 may determine whether the transfer film piece 52 has been inverted by the inverting operation based on a reading result from the inversion verification device.

In the above-described embodiment, the print system 100 may include a peeling device. The peeling device may be disposed further downstream than the heat press device 21 in the pallet transport direction. The peeling device may include a gripper.

The peeling device may peel the transfer film piece 52 from the transfer-receival shirt 61 on the pallet 31 in the state in which the pallet 31 is disposed at the discharge position P13. In this case, the peeling device may grip the section of the secondary additional information L2 using the gripper. When the primary additional information L1 is formed on the transfer film piece 52, the peeling device may grip the section of the primary additional information L1 using the gripper.

In the above-described embodiment, the reading device 78 reads the primary additional information L1 from the transfer film 51 that has passed through the adhesive layer formation process. In contrast to this, the reading device 78 may read the primary additional information L1 from the transfer film 51 prior to the adhesive layer formation process.

In the above-described embodiment, the powder shaker 12 may include the reading device 78. The printer 11 may include the reading device 78. The sheet cutter 13 may be disposed between the printer 11 and the powder shaker 12 in the sheet transport direction. A separate inkjet printer to be described below may include the reading device 78. In these cases, the sheet cutter 13 may include the reading device 78 or may omit the reading device 78.

In the above-described embodiment, the placement transfer robot 41 may dispose the transfer film piece 52 on the transfer-receival shirt 61 such that part of the transfer film piece 52 protrudes beyond the transfer-receival shirt 61 when seen from above. Hereinafter, a section of the transfer film piece 52 that protrudes beyond the transfer-receival shirt 61 as seen from above, when the placement transfer robot 41 has disposed the transfer film piece 52 on the transfer-receival shirt 61, will be simply referred to as a “protruding section”. In this case, the laser head 73 may form the secondary additional information L2 on the protruding section. The printer 11 may print the primary additional information L1 on the protruding section.

When the print system 100 includes the above-described peeling device, the peeling device may grip the protruding section using the gripper.

In the above-described embodiment, some of the corresponding data stored by the external server 99 may be stored in the flash memory 92. The primary additional information L1 may include some or all of the data relating to the corresponding image ID. In a similar manner to the primary additional information L1, the secondary additional information L2 may also include some or all of the data relating to the corresponding image ID.

In the above-described embodiment, the CPU 91 need not necessarily communicate with the external server 99. In this case, the corresponding data may be stored in the flash memory 92. The primary additional information L1 may include part of all of the corresponding data of the corresponding image ID. For example, the primary additional information L1 may include the position information of the image L0 with respect to the transfer film 51. In this case, the sheet cutter 13 contributes to the primary additional information L1 and the secondary additional information L2 being used depending on whether it is the transfer process or another of the processes.

In a similar manner to the primary additional information L1, the secondary additional information L2 may also include all or some of the corresponding image ID.

The data representing the primary additional information L1 and the data representing the secondary additional information L2 may be different from each other.

The primary additional information L1 and the secondary additional information L2 may include data to identify a correlation between a print position and an angle of the primary additional information L1 and a print position and an angle of the image L0.

The primary additional information L1 and the secondary additional information L2 may include data to identify a transfer position and an angle of the image L0 on the transfer-receival shirt 61.

In the above-described embodiment, the additional information may include information to distinguish one of the transfer films 51 from another of the transfer films 51. The additional information may include information to distinguish one of the transfer film pieces 52 from another of the transfer film pieces 52. The additional information may include information to distinguish one of the transfer-receival shirts 61 from another of the transfer-receival shirts 61.

In the above-described embodiment, the reading device 78 may be disposed below the transport path of the transfer film 51.

In the above-described embodiment, the sheet cutter 13 may include the multiple laser heads 73. In this case, the cutting procedure and the formation procedure may be performed by the respective laser heads 73. The laser head 73 for performing the laser mark forming procedure may be disposed in a separate device from the sheet cutter 13.

In the above-described embodiment, the secondary additional information L2 may be formed by a method different from the laser mark forming procedure by the laser light 73L. For example, the sheet cutter 13 may include an etching rod. In this case, the sheet cutter 13 may etch the surface of the transfer film 51 with the etching rod, along the shape of the secondary additional information L2.

For example, the sheet cutter 13 may include a dot pin. In this case, by striking the transfer film 51 with the dot pin, the sheet cutter 13 may cause the surface of the transfer film 51 to be indented along the shape of the secondary additional information L2.

The printer 11 may eject multiple types of ink from the inkjet head 111. The multiple types of ink may include fast-drying or slow-drying inks, for example. A drying speed of the fast-drying ink is higher than a drying speed of the slow-drying ink. For example, the speed at which the fast-drying ink dries may be approximately from an end time point of the image formation process to a start time point of the adhesive layer formation process.

In this case, the printer 11 may print the image L0 on the transfer film 51 using the slow-drying ink. The printer 11 may print the primary additional information L1 on the transfer film 51 using the fast-drying ink. A separate inkjet printer may print the primary additional information L1 on the transfer film 51 using the fast-drying ink, in place of the printer 11.

In the above-described embodiment, the print system 100 may include the separate inkjet printer from the printer 11. The separate inkjet printer may be disposed in the powder shaker 12. The separate inkjet printer may be disposed further downstream than the powder shaker 12 in the sheet transport direction. The separate inkjet printer is preferably disposed further upstream than the laser head 73 in the sheet transport direction.

The separate inkjet printer may print the primary additional information L1 on the transfer film 51 in place of the printer 11. For example, the separate inkjet printer may print the primary additional information L1 on the transfer film 51 in the adhesive layer formation process, subsequent to the powder being applied to the transfer film 51.

A timing subsequent to the powder being applied to the transfer film 51 may be a timing prior to the adhesive layer L3 being formed, for example. The timing prior to the adhesive layer L3 being formed is a timing prior to the applied powder being melted by the heater 122. In this case, the powder shaker 12 can dry the ink forming the primary additional information L1 using the heat emitted by the heater 122.

The timing subsequent to the powder being applied to the transfer film 51 may be a timing during the formation of the adhesive layer L3, for example. The timing during the formation of the adhesive layer L3 is a timing in the middle of the applied powder being melted by the heater 122. The timing in the middle of the applied powder being melted by the heater 122 is a period from a start of the heating by the heater 122 to an end of the heating. In this case, the powder shaker 12 can dry the ink forming the primary additional information L1 using the heat emitted by the heater 122, while suppressing the powder from attaching to the primary additional information L1.

The timing subsequent to the powder being applied to the transfer film 51 may be a timing subsequent to the formation of the adhesive layer L3, for example. In this case, a possibility of the powder attaching to the primary additional information L1 is further suppressed.

The printer 11 may perform double-sided printing. In this case, in place of the transfer film 51, the already cut transfer film piece 52 is preferably set in the printer 11. The printer 11 may print the image L0 on the receival layer 512 of the transfer film piece 52, and may print the primary additional information L1 on the base material 511. In other words, the printer 11 may print the image L0 on the back surface of the transfer film piece 52, and may print the primary additional information L1 on the front surface.

In place of the target additional information L6, an RF tag may be attached to the transfer-receival shirt 61.

In the above-described embodiment, the CPU 91 may use the same position as the cutting position and the formation position of the secondary additional information L2.

In the above-described embodiment, the processing at S53 may be performed on the transfer film 51 prior to the ejection of the ink by the inkjet head 111.

In the above-described embodiment, in the processing at S53, the CPU 91 may form the secondary additional information L2 on the transfer film 51 without being based on the primary additional information L1. In other words, in the processing at S52, the CPU 91 may generate the secondary additional information L2 without being based on the primary additional information L1.

In the above-described embodiment, the heat press device 21 need not necessarily include the heater 213.

In the above-described embodiment, in the powder shaker 12, the application spray 121 and the heater 122 may be disposed in separate devices, respectively.

In the above-described embodiment, the application method of the powder onto the transfer film piece 52 by the powder shaker 12 may be changed. For example, a spatula may be used in place of the application spray 121, or a powder head may be used.

In the above-described embodiment, the method of melting the powder by the powder shaker 12 may be changed. For example, a laser head may be used in place of the heater 122.

The primary additional information L1 and the secondary additional information L2 may be different types from each other. For example, the primary additional information L1 may be code information, and the secondary additional information L2 may be character information. The primary additional information L1 may be one-dimensional code information, and the secondary additional information L2 may be two-dimensional code information. In a similar manner, the target additional information L6 may also be different from the primary additional information L1 and the secondary additional information L2.

In the above-described embodiment, in the processing at S54, the laser head 73 cuts out the transfer film piece 52 from the transfer film 51. In other words, the laser head 73 does not cut from one end to the other end of the transfer film 51 in the width direction. The width direction is the left-right direction. In contrast to this, the laser head 73 may cut the transfer film 51 from the one end to the other end in the width direction. In this case, the sheet transport motor 770 may drive one or both of the tension rollers 751 and 752, for example, and transport the transfer film 51.

The transport method of the transfer film 51 may be changed from that of the above-described embodiment. The transfer film 51 may be transported by a belt conveyor. The transfer film 51 may be placed on a platen. In this case, the print system 100 may transport the platen. The platen is a plate.

In the above-described embodiment, the print system 100 may further include one or more CPUs in addition to the CPU 91. For example, the printer 11, the powder shaker 12, and the heat press device 21 may each include a CPU. In this case, the CPU 91 may perform mutual communication with the CPUs of each of the devices, and may execute the main processing.

An order of each of the processing steps in the main processing may be changed from that of the above-described embodiment. For example, the CPU 91 may perform the processing at S53 subsequent to the processing at S54. The CPU 91 may perform the processing at S63 subsequent to the processing at S64.

In place of the CPU 91, a microcomputer, an application specific integrated circuit (ASIC), a field programmable gate array (FPGA), or similar devices may be used as a processor. The main processing may be performed as distributed processing by multiple the processors.

Non-transitory storage media, such as the flash memory 92 may include any storage media capable of storing information, regardless of a period of storing the information. The non-transitory storage media may exclude transitory storage media. The transitory storage media is, for example, transmitted signals. The control program may be downloaded from a server connected to a network, in other words, transmitted as transmission signals and then stored in the flash memory 92. In this case, the control program may be stored in a non-transitory storage medium, such as an HDD of the server.

What is claimed is:

1. A processing device comprising:
a process portion configured to perform medium processing on a transfer medium, subsequent to or prior to ejection of ink, the ink being configured to form an image to be transferred from the transfer medium to a transfer-receival medium;
a processor; and
a memory storing computer-readable instructions that, when executed by the processor, instruct the processor to perform a process comprising:
causing the process portion to perform one of
the medium processing of forming additional information on the transfer medium in a non-transfer mode, or
the medium processing of implementing a restriction procedure on the additional information formed on the transfer medium, or
the medium processing of implementing an image transfer procedure on the image formed on the transfer medium, and not implementing an information transfer procedure on the additional information formed on the transfer medium, wherein
the non-transfer mode is a mode in which the additional information is not transferred from the transfer medium to the transfer-receival medium in a transfer process of transferring the image from the transfer medium to the transfer-receival medium,
the restriction procedure is a procedure that restricts the information transfer procedure from being implemented on the additional information formed on the transfer medium,
the information transfer procedure is a procedure for transferring the additional information from the transfer medium to the transfer-receival medium in the transfer process, and
the image transfer procedure is a procedure for transferring the image from the transfer medium to the transfer-receival medium in the transfer process.

2. The processing device according to claim 1, wherein
in the transfer process, the image is configured to be transferred from the transfer medium to the transfer-receival medium by the transfer medium being pressed against the transfer-receival medium,
the transfer medium includes a facing surface being configured to face the transfer-receival medium in the transfer process,
the facing surface includes a press region being configured to be pressed against the transfer-receival medium in the transfer process, and
the computer-readable instructions instruct the processor to perform a process comprising:
causing the process portion to perform the medium processing of forming the additional information in a region of the transfer medium different from the press region as the non-transfer mode.

3. The processing device according to claim 2, wherein
the image is configured to be transferred from the transfer medium to the transfer-receival medium by the transfer medium being pressed against the transfer-receival medium by a press device, and
the computer-readable instructions instruct the processor to perform a process comprising:
causing the process portion to perform the medium processing of forming the additional information in the region different from the press region of the transfer medium as the non-transfer mode, the additional information including position information of the transfer medium with respect to the press device in the transfer process.

4. The processing device according to claim 3, wherein
the computer-readable instructions instruct the processor to perform a process comprising:
causing the process portion to perform the medium processing of forming the additional information in the region different from the press region of the transfer medium as the non-transfer mode, the additional information including position information of the image with respect to the transfer medium.

5. The processing device according to claim 1, wherein
separate additional information separate from the additional information includes position information of the image with respect to the transfer medium, and
the computer-readable instructions instruct the processor to perform a process comprising:
causing the process portion to perform one of
the medium processing of forming the additional information in the non-transfer mode at a position, of the transfer medium, different from a position at which the separate additional information is formed, or
the medium processing of implementing the restriction procedure on the additional information formed at the position, of the transfer medium, different from the position at which the separate additional information is formed, or
the medium processing of implementing the image transfer procedure on the image formed on the transfer medium, and not implementing the information transfer procedure on the additional information formed at the position, of the transfer medium, different from the position at which the separate additional information is formed.

6. The processing device according to claim 5, wherein
subsequent to the medium processing being performed by the process portion, the transfer medium is cut into an image region and an information region,
the image region includes the image,
the information region includes the separate additional information, and
the computer-readable instructions instruct the processor to perform a process comprising:
causing the process portion to perform one of
the medium processing of forming the additional information in the image region of the transfer medium in the non-transfer mode, or
the medium processing of implementing the restriction procedure on the additional information formed in the image region of the transfer medium, or
the medium processing of implementing the image transfer procedure on the image formed in the image region of the transfer medium, and not implementing the information transfer procedure on the additional information formed in the image region of the transfer medium.

7. The processing device according to claim 5, wherein
the computer-readable instructions instruct the processor to perform a process comprising:
causing the process portion to perform the medium processing of forming the additional information in the non-transfer mode based on the separate additional information, in a state of the separate additional information being formed on the transfer medium.

8. The processing device according to claim 1, wherein
the computer-readable instructions instruct the processor to perform a process comprising:
causing the process portion to perform one of
the medium processing of attaching a sticker to the transfer medium in an orientation in which the additional information is disposed between a front surface of the sticker and the transfer medium as the non-transfer mode, the additional information being formed on the sticker, or
the medium processing of covering the additional information formed on the transfer medium with the sticker as the restriction procedure.

9. A control method for controlling a process portion configured to perform medium processing on a transfer medium, subsequent to or prior to ejection of ink, the ink being configured to form an image to be transferred from the transfer medium to a transfer-receival medium, the control method comprising:
causing the process portion to perform one of
the medium processing of forming additional information on the transfer medium in a non-transfer mode, or
the medium processing of implementing a restriction procedure on the additional information formed on the transfer medium, or
the medium processing of implementing an image transfer procedure on the image formed on the transfer medium, and not implementing an information transfer procedure on the additional information formed on the transfer medium, wherein
the non-transfer mode is a mode in which the additional information is not transferred from the transfer medium to the transfer-receival medium in a transfer process of transferring the image from the transfer medium to the transfer-receival medium,
the restriction procedure is a procedure that restricts the information transfer procedure from being implemented on the additional information formed on the transfer medium,
the information transfer procedure is a procedure for transferring the additional information from the transfer medium to the transfer-receival medium in the transfer process, and
the image transfer procedure is a procedure for transferring the image from the transfer medium to the transfer-receival medium in the transfer process.

10. A transfer medium comprising:
a base material;
a receival layer being a layer disposed on the base material and being a layer subsequent to or prior to ink being ejected thereon, the ink being configured to form an image to be transferred to a transfer-receival medium; and
additional information, wherein
the additional information is formed on the transfer medium in a non-transfer mode, or
a restriction procedure is implemented on the additional information, or
an image transfer procedure is implemented on the image formed by the ink received by the receival layer, and an information transfer procedure is not implemented on the additional information,
the non-transfer mode is a mode in which, in a transfer process of transferring the image formed by the ink received by the receival layer from the transfer medium to the transfer-receival medium, the additional information is not transferred from the transfer medium to the transfer-receival medium,
the restriction procedure is a procedure that restricts the information transfer procedure from being implemented on the additional information,
the information transfer procedure is a procedure for transferring the additional information from the transfer medium to the transfer-receival medium in the transfer process, and
the image transfer procedure is a procedure for transferring the image from the transfer medium to the transfer-receival medium in the transfer process.
